(19) United States
(12) Patent Application Publication
(10) Pub. No.: US 2013/0317872 A1
(43) Pub. Date: Nov. 28, 2013

(54) AGRICULTURAL WORK SUPPORT METHOD AND APPARATUS

(71) Applicant: FUJITSU LIMITED, Kawasaki-shi (JP)

(72) Inventor: Koji NAKAMICHI, Yokohama (JP)

(73) Assignee: FUJITSU LIMITED, Kawasaki-shi (JP)

(21) Appl. No.: 13/960,506

(22) Filed: Aug. 6, 2013

Related U.S. Application Data
(63) Continuation of application No. PCT/JP2011/055709, filed on Mar. 10, 2011.

(51) Int. Cl. G06Q 10/06

(52) U.S. Cl. CPC G06Q 10/063114
USPC 705/7.15

(57) ABSTRACT

An agricultural work support method is disclosed. In the agricultural work support method, an advent of an evaluation time of a performed agricultural work task is detected based on a performance time and a calculation method of the evaluation time of an achievement of the agricultural work task, in which a work history storage part stores the performance time for each of multiple agricultural work tasks, and a calculation method storage part stores the performance time as a reference in the calculation method. Then, an instruction of an evaluation work of the achievement pertinent to the agricultural work task, in which the advent of the evaluation time is detected, is output.

### CROSS-REFERENCE TO RELATED APPLICATION

This application is a continuation of International Application PCT/JP2011/055709 filed on Mar. 10, 2011 and designated the U.S., the entire contents of which are incorporated herein by reference.

### FIELD

The present invention is related to an agricultural work support method and an agricultural work support apparatus.

### BACKGROUND

In cultivation of crops in agriculture, various work activities occur in a period to harvest and shipment through a growing phase from turning over soil and sowing (seeding). A basic factor for determining timing of each of the various work tasks is a growing period. In particular, work tasks are roughly determined based on lapsed days from a day of sowing (seeding), or fixed planting or transplanting (planting a seedling in a field). According to “Agricultural Technology Encyclopedia: Basics of Cabbage 98”, it is suggested that for cabbage, additional fertilization (applying fertilizer) be performed 30 days and 80 days after the fixed planting.

However, in practice, circumstances other than the growing period of the crops are considered. Circumstances changeable for each farm field, such as a circumstance of a farm field (field), states of the farm field (states of soil and periphery of the farm field), a weather condition, and the like, may be important factors to determine work tasks to do.

Specifically, as a work task corresponding to a circumstance of occurrences of disease and insect pest prevention, for cabbage after the fixed planting, it may be considered to spray pesticide on the farm field upon an occurrence of insects (caterpillars of cabbage butterflies and the like). Also, as a work task corresponding to the circumstance of the farm field, regarding irrigated rice after rice planting, it may be considered to make the rounds around the path between rice fields and to confirm there is no water leakage when water is being intensely dried up (water level is lowered). Also, as a work task corresponding to the weather condition or the soil condition, in the turning over before sowing, it may be considered that no work task is conducted for three days (one week for a farm field of poor drainage) after rainfall.

Also, by using a computer system, it is considered to determine contents of the work tasks to do by considering a growing state in addition to the growing period (refer to Japanese Laid-open Patent Publication No. 2007-310463).

### SUMMARY

According to one aspect of an embodiment, an agricultural work support method performed in a computer is provided, the method including: detecting an advent of an evaluation time of a performed agricultural work task based on a performance time and a calculation method of the evaluation time of an achievement of the agricultural work task, in which a work history storage part stores the performance time for each of multiple agricultural work tasks, and a calculation method storage part stores the performance time as a reference in the calculation method; and outputting an instruction of an evaluation work task of the achievement pertinent to the agricultural work task in which the advent of the evaluation time is detected.

The object and advantages of the invention will be realized and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF DRAWINGS

FIG. 1 is a diagram illustrating a hardware configuration example of an agricultural work support apparatus in an embodiment;

FIG. 2 is a diagram illustrating a functional configuration example of the agricultural work support apparatus in the embodiment;

FIG. 3 is a flowchart for explaining an example of a process procedure of a growing state update process;

FIG. 4 is a diagram illustrating a configuration example of growing state information;

FIG. 5 is a diagram illustrating a configuration example of a growing state update rule;

FIG. 6 is a diagram illustrating a configuration example of a work history storage part;

FIG. 7 is a diagram illustrating a configuration example of an observation rule which is referred to by the growing state update rule;

FIG. 8 is a diagram illustrating examples of the growing state update rule and the observation rule as process subjects in the growing state update process;

FIG. 9 is a diagram illustrating a configuration example of the growing stage history storage part;

FIG. 10 is a diagram illustrating examples of the growing state update rule and the observation rule related to a growing stage which ends when the work task is completed;

FIG. 11 is a diagram illustrating examples of the growing state update rules and the observation rules used to correct the growing state information depending on an actual growing state;

FIG. 12 is a flowchart for explaining an example of a process procedure of a first extraction process of a work rule depending on the growing state;

FIG. 13 is a diagram illustrating a configuration example of the growing state rule;

FIG. 14 is a flowchart for explaining an example of a process procedure of a second extraction process of the work rule depending on the observation information;

FIG. 15 is a diagram illustrating a configuration example of the observation rule as the work rule;

FIG. 16 is a flowchart for explaining an example of a process procedure of a third extraction process of the work rule depending on the environmental information;

FIG. 17 is a diagram illustrating a configuration example of an environmental information storage part;

FIG. 18 is a diagram illustrating a configuration example of an environmental rule;

FIG. 19 is a flowchart for explaining an example of a process procedure of a fourth extraction process of the work rule depending on the alarm information;

FIG. 20 is a diagram illustrating a configuration example of an alarm rule;

FIG. 21 is a flowchart for explaining an example of a process procedure of an output process of a work instruction;

FIG. 22 is a flowchart for explaining an example of a process procedure of the first detection process of the advent of an evaluation time pertinent to a performed work task;

FIG. 23 is a diagram illustrating a configuration example of an evaluation time calculation reference storage part;

FIG. 24 is a flowchart for explaining an example of a process procedure of a second detection process of an advent of an evaluated date based on a cumulative temperature;

FIG. 25 is a diagram illustrating a configuration example of a farm field feature information storage part;

FIG. 26 is a flowchart for explaining an example of a process procedure of a third detection process of the advent of the evaluated date based on a pesticide valid term;

FIG. 27 is a diagram illustrating a configuration example of a pesticide information storage part;

FIG. 28 is a diagram illustrating a configuration example of an evaluation value correction coefficient storage part;

FIG. 29 is a flowchart for explaining an example of a process procedure of a correction process of the pesticide valid term;

FIG. 30 is a flowchart for explaining an example of a process procedure of a first input process of the work achievement;

FIG. 31 is a flowchart for explaining an example of a process procedure of a second input process of a rule goal achievement evaluation value;

FIG. 32 is a diagram illustrating an example of a relationship between the work rule and a stage goal; and

FIG. 33 is a flowchart for explaining an example of a process procedure of a calculation process of a contribution of the work rule.

### DESCRIPTION OF EMBODIMENT

Like “Agricultural Technology Encyclopedia: Basics of Cabbage 98”, how to conduct what work task depending on a growing period and a growing phase (growing stage) is taken in context in a form of a cultivation standard and guideline information for each crop. Also, a seed and seedling manufacturer, who sells seeds and seedlings, describes information of an appropriate cultivation season in a catalogue, each of containers of seeds, and the like, for each crop or each variety.

However, in the cultivation standard or the guideline information, basic work tasks (sowing, fertilization, and harvest) are simply described depending on the growing period or the growing phase for each of cropping types (spring sowing type, autumn sowing type, and the like) and rough weather conditions (a cool place, a mild place, a warm place, and the like). Also, in a technology described in the Japanese Laid-open Patent Publication No. 2007-310463, a work type is roughly presented. Furthermore, the cultivation standard, the guideline information, or the like is not always proper for a specific farm field.

In view of the foregoing, it may be efficient to evaluate validity of a standard, a guideline, or the like referred to during repetition of cultivation by a worker, and to extract the standard, the guideline, or the like which is proper for the specific farm field, or to produce a new creation and the like based on an evaluation result.

However, there is a large variety of agricultural work tasks. Accordingly, in particular, it is difficult for a less experienced worker to determine a timing of evaluating an achievement for each of agricultural work tasks. Also, even a highly experienced worker may accidentally forget things to evaluate and the timing of the evaluation.

Therefore, in the following, an agricultural work support method and an agricultural work support apparatus will be presented to support evaluating the achievement of the agricultural work task.

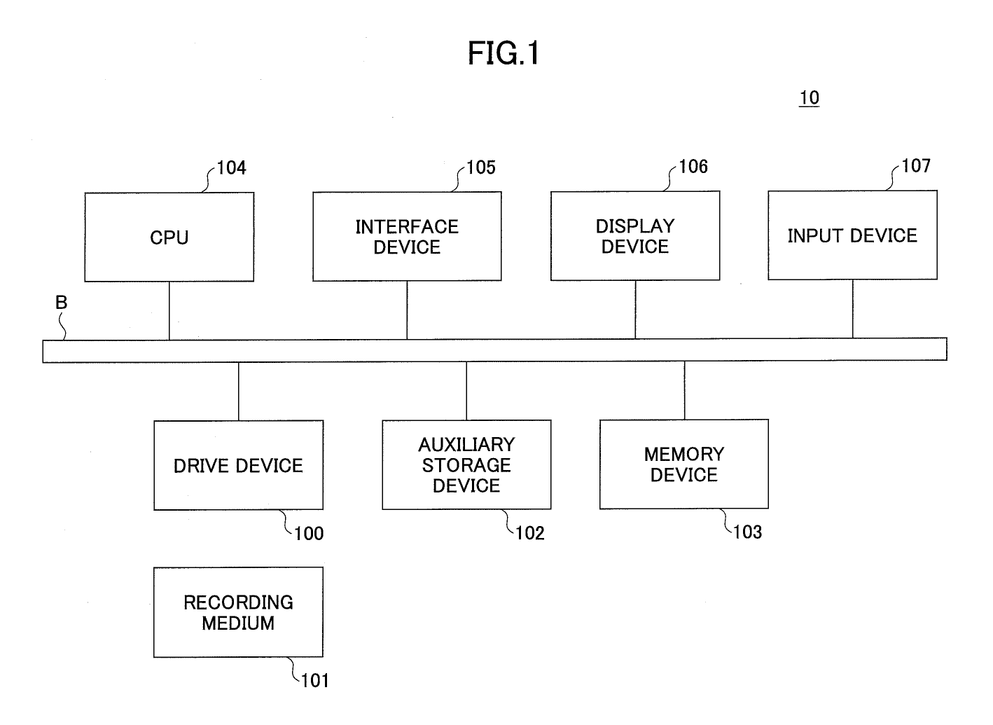

An embodiment is described with reference to drawings. FIG. 1 is a diagram illustrating a hardware configuration example of an agricultural work support apparatus 10 in the embodiment. In FIG. 1, the agricultural work support apparatus 10 includes a drive device 100, an auxiliary storage device 102, a memory device 103, a CPU (Central Processing Unit) 104, an interface device 105, a display device 106, and an input device 107, which are mutually connected via a bus B.

A program realizing a process in the agricultural work support apparatus 10 may be provided by a recording medium 101. When the recording medium 101 storing the program is set to the drive device 100, the program is installed from the recording medium 101 to the auxiliary storage device 102 through the drive device 100. The program is not always installed from the recording medium 101. The program may be downloaded from another computer through a network. The auxiliary storage device 102 stores files, data, and the like in addition to storing the installed program. The recording medium 101, the auxiliary storage device 102, and the memory device 103 may form a storage part.

When the CPU 104 is instructed to execute the program, the program is read from the auxiliary storage device 102 and stored in the memory device 103. The CPU 104 realizes functions pertinent to the agricultural work support apparatus 10 in accordance with the program stored in the memory device 103. The interface device 105 is used as an interface to connect to the network. The display device 106 displays a GUI (Graphical User Interface) and the like by the program. The input device 107 may include a keyboard, a mouse, and the like, and may be used to input various operation instructions.

A portable recording medium such as a CD-ROM (Compact Disk Read Only Memory), a DVD (Digital Versatile Disk), a USB (Universal Serial Bus) memory, or the like, may be used as examples of the recording medium 101. Also, a HDD (Hard Disk Drive), a flash memory, or the like may be used as examples of the auxiliary storage device 102. Any of the recording medium 101 and the auxiliary storage device 102 corresponds to a non-transitory (or tangible) computer-readable recording medium.

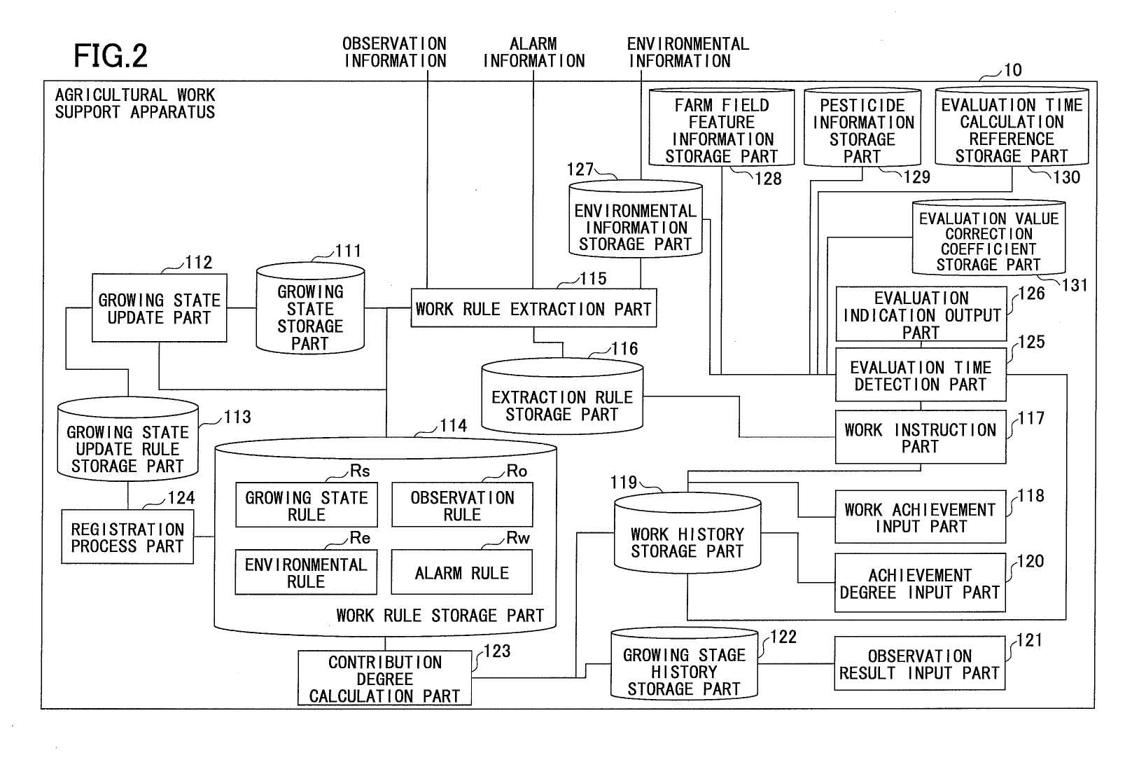

FIG. 2 is a diagram illustrating a functional configuration example of the agricultural work support apparatus 10 in the embodiment. In FIG. 2, the agricultural work support apparatus 10 includes a growing state update part 112, a work rule extraction part 115, a work instruction part 117, a work achievement input part 118, an achievement degree input part 120, an observation result input part 121, a contribution degree calculation part 123, a registration process part 124, an evaluation time detection part 125, an evaluation indication output part 126, and the like. Each of the parts 112, 115, 117, 118, 120, 121, 123, 124, 125, and 126 is realized by a process which the program installed into the agricultural work support apparatus 10 causes the CPU 104 to execute.

The agricultural work support apparatus 10 also includes a growing state storage part 111, a growing state update rule storage part 113, a work rule storage part 114, an extraction rule storage part 116, a work history storage part 119, a growing stage history storage part 122, an environmental information storage part 127, a farm field feature information storage part 128, a pesticide information storage part 129, an evaluation time calculation reference storage part 130, an evaluation value correction coefficient storage part 131, and the like. Each of the parts 111, 113, 114, 116, 119, 122, 127, 128, 129, 130, and 131 is realized by using the auxiliary storage device 102, a storage apparatus or the like connected to the agricultural work support apparatus 10 through the network. It is preferable to realize the extraction rule storage part 116 by using the memory device 103.

The growing state storage part 111 stores information (growing state information) indicating the growing state of a crop for each of cultivated crops. The growing state information may be regarded as information indicating the growing state of the crop as the basis for passage of time. The growing state information includes a characteristic growing stage (growing phase) for each of the crops, lapsed days from a cultivation start day, lapsed days from a start day from each of the growing stages, and the like. The growing stage corresponds to one of terms in which a predetermined term in a growing process of the crop is divided or classified into segments. The growing stage of the crop is approximately classified into a “sowing season (seeding season)”, a “raising seedling season”, a “growing season”, a “cultivation season”, and the like. Also, in a case of applying the embodiment, arbitrary growing stages may be defined.

The growing state update part 112 updates the growing state information stored in the growing state storage part 111. The growing state update part 112 automatically updates the growing state of the crop for each predetermined term, for one predetermined term. The growing state update part 112 increases the lapsed days by one day every day. Also, the growing state update part 112 updates the growing stage of the growing state when the growing state meets any condition in a growing state update rule Ru.

The growing state update rule Ru may be regarded as data which define what to observe at a characteristic time point of the growing process of the crop, how to update the growing state information (an update value of the growing state information) as an observation result, and the like. That is, the growing state update rule Ru includes the characteristic time point of the growing process of the crop as the condition. Also, the growing state update rule Ru includes contents to observe when the condition is satisfied, the update value of the growing state information corresponding to the observation result.

The growing state update rule storage part 113 stores at least one growing state update rule Ru.

The work rule storage part 114 stores various work rules. The work rule may be regarded as data which define what work task to do or the like, based on various states pertinent to a crop state, which is a peripheral state of a farm field site (a crop environmental state). Specifically, the work rule may include a condition pertinent to crop growing state information or the crop environmental state, work information indicating a work task to perform when the condition is satisfied, a contribution degree of the work rule (or the work task) with respect to a crop growth, and the like. The contribution degree will be described later in detail.

In FIG. 2, a growing state rule Rs, an observation rule Ro, an environmental rule Re, an alarm rule Rw, and the like are illustrated as work rules. Each of the work rules will be described in detail.

The work rule extraction part 115 extracts (or retrieves) the work rule including the condition which meets input information of the growing state information of the crop, information pertinent to the peripheral state of the farm field site, and the like, from the work rule storage part 114. As an example of the input information, in the embodiment, the following information may be used: the growing state information stored in the growing state storage part 111, observation result information of the farm field by a person, information pertinent to an environment (soil or weather) of the farm field by each of various measuring equipment or sensors, various alarm information provided by a weather information provider or an agricultural related organization, or the like. Types of the work rules in the embodiment correspond to types of the input information.

The extraction rule storage part 116 stores the work rule extracted by the work rule extraction part 115.

The work instruction part 117 may output the work information and the like included in the work rules stored in the extraction rule storage part 116. When multiple work rules are stored in the extraction rule storage part 116 (that is, when the multiple work rules are extracted), the work instruction part 117 selects (restricts) the work rule being an output subject of the work information based on the contribution degree included in each of the multiple work rules. That is, the work rule having a relatively higher contribution degree may be prioritized. That is, the contribution degree may be used as a priority degree (a priority order) when the multiple work rules compete with each other.

An execution time of processes by the work rule extraction part 115 and the work instruction part 117 may be every time the input information is input. Alternatively, the execution time may be timing set beforehand or a periodic time (a predetermined time every day or the like).

The evaluation time detection part 125 detects an advent of a time (an evaluation time) to perform an evaluation work of an evaluation value (a rule goal achievement evaluation value) indicating an achievement (or an achievement state) with respect to a goal (a rule goal) included in each of the work rules. Also, an achievement degree with respect to the rule goal may correspond to the evaluation value indicating a degree of a work result from performing in accordance with the work rule. A time from when the work task is conducted in accordance with the work rule to the evaluation time may be varied depending on a performed work task. It takes a few days to acquire an effect by an agricultural chemical spray. Accordingly, it is proper to consider the evaluation time pertinent to the agricultural chemical spray to be a few days after a work performance date. On the other hand, it is possible to simultaneously evaluate a performance of the work task related to the sowing and its result. Accordingly, it is proper to consider the evaluation time pertinent to the sowing to be the same date as the work performance date.

Also, even for the same work task, a proper evaluation time may be different depending on an environmental state such as weather or the like, characteristics of the farm field, and the like. Furthermore, a proper evaluation time for the agricultural chemical spray may be different depending on the pesticide to spray. The evaluation time detection part 125 refers to the environmental information storage part 127, the farm field feature information storage part 128, the pesticide information storage part 129, the evaluation time calculation reference storage part 130, and the like, and determines the advent of the evaluation time, in order according to the above circumstances.

The environmental information storage part 127 stores a history of environmental information. The environmental information includes information (especially, meteorological information) pertinent to an environment of the farm field such as temperature, sunshine duration, humidity, precipitation, and the like. The environmental information may be measured by various measuring equipment or sensors (a thermometer, a hygrometer, and the like) pertinent to the environment of the farm field, which are arranged in the farm field. A process result of a measurement value by each of the various measuring equipment and the like may be regarded as the environmental information. The process result may include an average temperature, a highest temperature, a lowest temperature, an accumulated temperature, an accumulated precipitation, and the like. That is, the process result may be a value which is not instantaneously acquired but is acquired based on the measured value in a fixed period. Also, the environmental information may be automatically recorded in the environmental information storage part 127 by connecting the various measuring equipment or the like with the agricultural work support apparatus 10. Alternatively, the environmental information may be manually input to the environmental information storage part 127.

The farm field feature information storage part 128 stores information (farm field characteristic information) indicating the characteristics of the farm field. In the embodiment, the farm field characteristic information includes a type of weed, which may occur in the farm field or which has a past record of an occurrence, and a condition which the weed incurs, for each farm field.

The pesticide information storage part 129 stores a valid term and the like for each pesticide (for each pesticide name).

The evaluation time calculation reference storage part 130 stores information indicating a calculation reference of the evaluation time for each of the works task.

The evaluation indication output part 126 outputs an execution instruction of the evaluation work related to the work task in which the advent of the evaluation time is detected by the evaluation time detection part 125. The evaluation work may include looking over the farm field for an evaluation, determining a rule goal achievement evaluation value, and the like. The evaluation value correction coefficient storage part 131 stores coefficients for correcting the rule goal achievement evaluation value.

The work achievement input part 118 receives an input of information (work achievement information) indicating a work achievement indicated by the work instruction part 117, and records the information (work achievement information) to the work history storage part 119. The work history storage part 119 may record a history of the work achievement information.

The achievement degree input part 120 receives an input of the rule goal achievement evaluation value from the worker. The achievement degree input part 120 records the received rule goal achievement evaluation value in the work history storage part 119. Accordingly, the rule goal achievement evaluation value is recorded for each of the work rules pertinent to the work task instructed to be done by the work instruction part 117.

The observation result input part 121 receives an input of the observation result with respect to the crop and the like performed in response to the observation instruction of the crop and the like output by the growing state update part 112. The observation result input part 121 records the evaluation value (a stage goal achievement evaluation value) indicating the achievement degree (an achievement state) with respect to a goal (a stage goal), which is set for each of the growing stages of the crop, to the growing stage history storage part 122 based on the input observation result. Accordingly, the stage goal achievement evaluation value pertinent to a certain crop is recorded for each of the growing stages of the certain crop.

The growing stage history storage part 122 records information pertinent to each of the growing stages in response to a progress of the growing stages of the crop. The information pertinent to each of the growing stages may also include the stage goal achievement evaluation value.

The contribution degree calculation part 123 acquires, for each of the growing stages, an index value indicating a correlation between the stage goal achievement evaluation value of the growing stage and the rule goal achievement evaluation value of each of the work rules applied in the growing stage, and records the index value to each of the work rules as the contribution degree. That is, the contribution degree is determined for each of the work rules based on the correlation between the achievement degree of the goal for each of the work rules and the achievement degree of the stage goal.

The registration process part 124 receives the input of the growing state update rule Ru or various types of the work rules, and records the growing state update rule Ru or the work rules which are input, to the growing state update rule storage part 113 or the work rule storage part 114. The registration process part 124 displays an input screen corresponding to the growing state update rule or each of the types of the work rules at the display device 106. The registration process part 124 generates the growing state update rule Ru or the work rules based on input contents corresponding to the input screen, and records the growing state update rule storage part 113 or the work rule storage part 114.

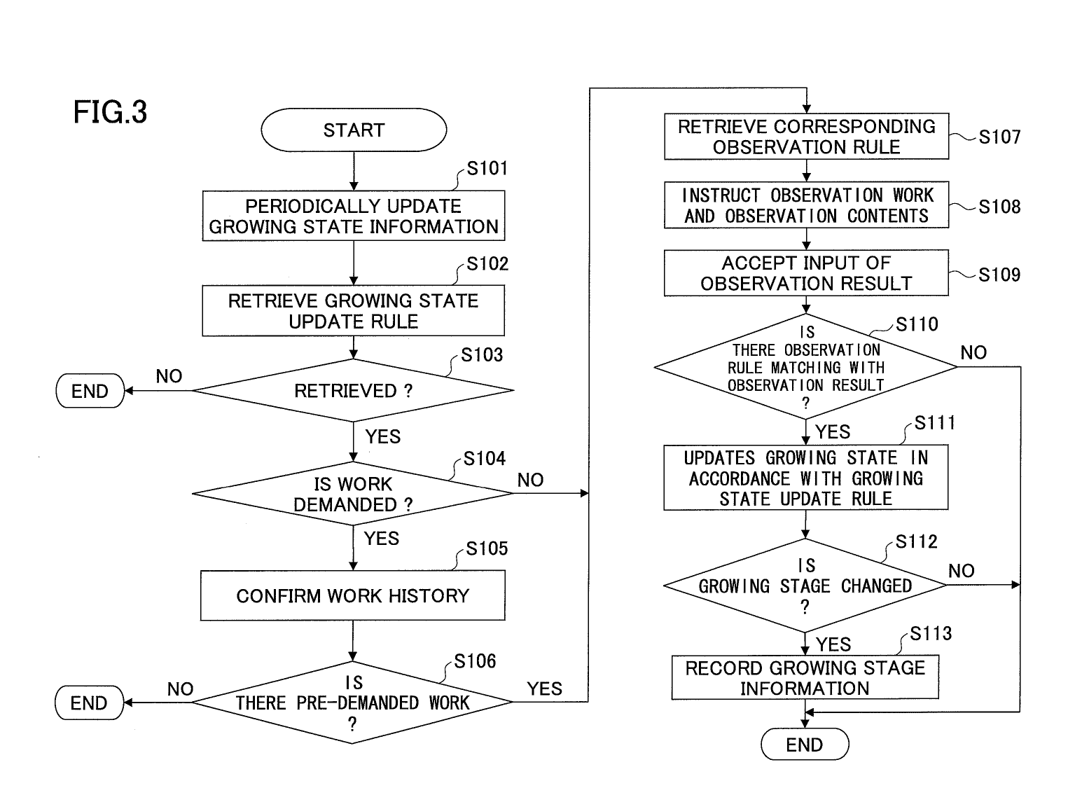

In the following, a process procedure of the agricultural work support apparatus 10 will be described. FIG. 3 is a flowchart for explaining an example of a process procedure of a growing state update process. The growing state update process in FIG. 3 is periodically performed. In the embodiment, the growing state update process is performed once at a predetermined time every day.

In step S101, the growing state update part 112 performs a periodical automatic update with respect to the growing state information stored in the growing state storage part 111.

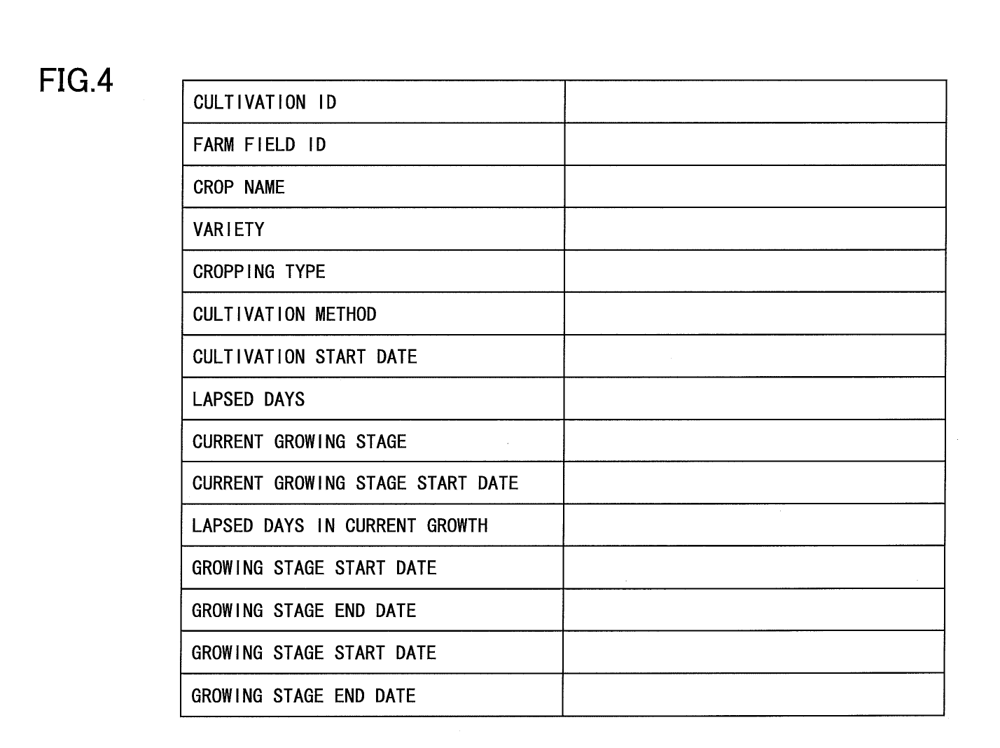

FIG. 4 is a diagram illustrating a configuration example of the growing state information. In FIG. 4, the growing state information includes items of a cultivation ID, a farm field ID, a crop name, a variety, a cropping type, a cultivation method, a cultivation start date, lapsed days, a current growing stage, a current growing stage start date, lapsed days in current growth, a growing stage start date, a growing stage end date, the growing stage start date, and the growing stage end date.

The cultivation ID is unique identification for each of cultivations of the crop. The “cultivation” includes various types of work tasks in a term from when the crop is cultivated or a preparation for cultivating the crop begins until the crop is harvested. The farm field ID is identification for the farm field. A unit of the farm field may be appropriately defined by corresponding to a farm to which the embodiment is applied.

The crop name is a name of the crop. A “rice”, an “oats”, and the like may correspond to the crop name. In a case of the “rice”, Koshihikari, Sasanishiki, and the like may correspond to the variety. The cropping type indicates a cultivation system of the crop such as the spring sowing type, autumn sowing type, and the like. The cultivation method corresponds to a method for cultivating the crop. The cultivation start date indicates a date when the cultivation started. The lapsed days indicate days lapsed from the cultivation start date. The current growing stage indicates a current growing stage of the crop. The current growing stage start date indicates a date when the growing stage is transitioned to the current growing stage. The lapsed days in the current growth indicate days lapsed after the transition to the current growth stage. The growth stage start date and the growth stage end date indicate a start date and an end date for each of the growth stages by now. In a case of passing multiple growth stages, the growing state information includes multiple sets of the growth stage start dates and the growth stage end dates respectively for the multiple growth stages.

In the growing state information, the farm field ID, the crop name, the variety, the crop type, the cultivation method, and the like correspond to information pertinent to a cultivation condition of the crop. After the cultivation start date, these items correspond to the information indicating the growing state of the crop. That is, in the embodiment, the growing state of the crop is managed in units of hours or based on time lapsed from the predetermined time. Also, instead of an actual cultivation start date, a date after a harvest of a preceding crop ends may be set as the cultivation start date of the crop, because there may be the work tasks such as maintenance (tilling, land leveling, fertilizer application, furrowing, and puddling) of the farm field for cultivating the crop before the cultivation (which may correspond to sowing) of the crop is actually performed.

The growing stage information illustrated in FIG. 4 is stored in the growth state storage part 111 for each cultivation. The process procedure in FIG. 3 is performed for each set of the growing state information stored in the growth state storage part 111. In the embodiment, for the sake of convenience, one set of the growing state information is focused on.

The periodical automatic update in step S101 increments the lapsed days and the lapsed days in the current growth in the growing state information by one, respectively. If a period performed in the process procedure in FIG. 3 is two days, the lapsed days and the lapsed days in the current growth in the growing state information may be incremented by two.

After that, the growing state update part 112 retrieves the growing state update rule Ru including a condition which meets the growing state information from the growing state update rule Ru stored in the growing state update rule storage part 113 (S102).

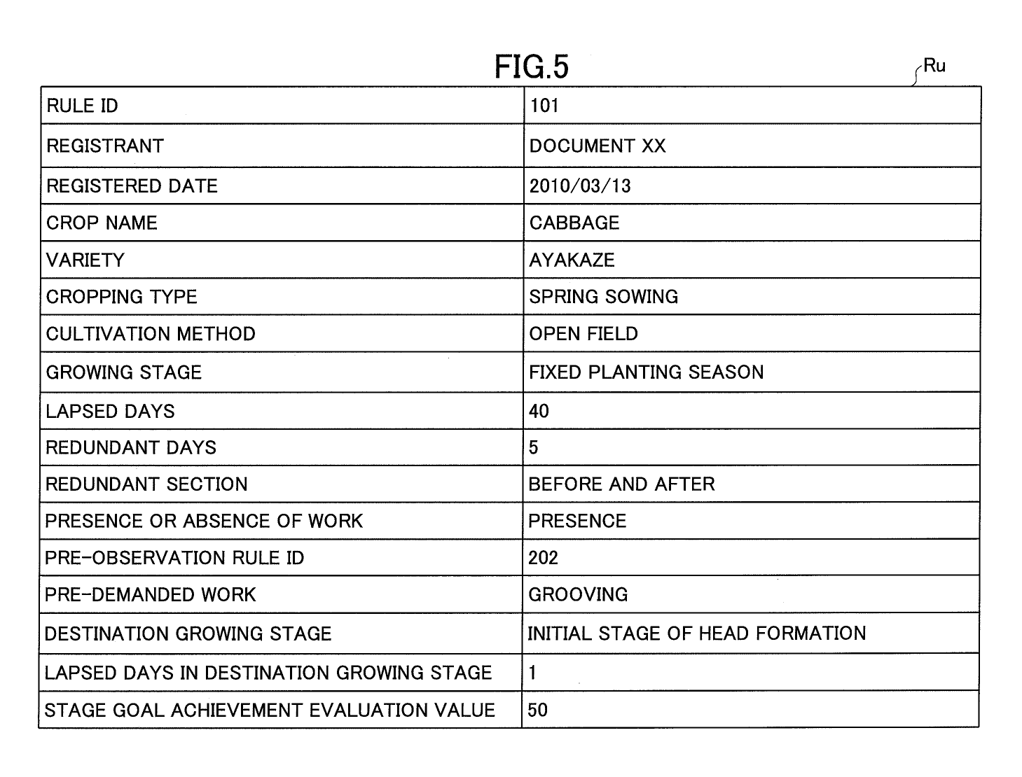

FIG. 5 is a diagram illustrating a configuration example of the growing state update rule. In FIG. 5, the growing state update rule Ru includes items of a rule ID, a registrant, a registered date, a crop name, a variety, a cropping type, a cultivation method, a growing stage, lapsed days, redundant days, a redundant section, a presence or absence of work, a pre-observation rule ID, a pre-demanded work, a destination growing stage, a lapsed days in destination growing stage, a stage goal achievement evaluation value, and the like.

The rule ID is unique identification for each of the growing state update rules Ru. The registrant corresponds to information indicating information source of the growing state update rule Ru, a registrant, or the like. That is, in the embodiment, it is assumed that each of the workers registers the growing state update rule Ru and the work rules by using various information items as a reference. Accordingly, by apparently storing information indicating that the growing state update rule Ru or the work rules are registered by whom or based on what information source or the like, it is possible to evaluate reliability of the growing state update rule Ru. The registered date indicates a date when the growing state update rule Ru is registered.

In the growing state update rule Ru, information from the crop name to the redundant section corresponds to parameters forming the condition (hereinafter, called a “growing state condition”) with respect to the growing state information. In the parameters, the crop name, the variety, the cropping type, the cultivation method, the growing state, and the lapsed days are as described for the growing state information (FIG. 4). The lapsed days indicate days lapsed in the growing state.

The redundant days corresponds to a parameter to have a redundancy in the condition of the lapsed days. That is, the redundancy is given to the condition of the lapsed days for a day number indicated by the redundant days.

The redundant section corresponds to a parameter indicating in which direction to apply the redundant days to the lapsed days. The redundant section takes a value “BEFORE AND AFTER”, “BEFORE”, or “AFTER”. The “BEFORE AND AFTER” indicates to apply the redundant days before and after the lapsed days. Accordingly, in a case of examples of the lapsed days and the redundant days in FIG. 5, if the redundant section indicates “BEFORE AND AFTER”, the condition of the lapsed days indicates “35-45”. If “BEFORE” indicates to apply the redundant days before the lapsed days. Accordingly, in this case, the condition of the lapsed days indicates “35-40”. If “AFTER” indicates to apply the redundant days after the lapsed days. Accordingly, in this case, the condition of the lapsed days indicates “40-45”.

The destination growing stage and the lapsed days in the destination growing stage are parameters forming contents of an update process with respect to the growing state information which meets the growing state condition of the growing state update rule Ru. That is, the destination growing stage indicates the update value (a value after the update) of the current growing stage of the growing state information. The lapsed days in the destination growing stage indicate the update value of the lapsed days in the destination growing stage.

The work presence or absence, the pre-observation rule ID, and the pre-demanded work correspond to additional conditions for the growing state condition. That is, the pre-observation rule ID corresponds to a condition pertinent to an actual observation state of the crop. Specifically, the pre-observation rule ID is regarded as a rule ID of the observation rule Ro to which the growing state update rule Ru is referred (or which the growing state update rule Ru includes). The observation rule Ro corresponds to a rule by which observation contents pertinent to the crop, the soil, and the like is regulated. In a case in which a value is recorded in the pre-observation rule ID, even if the growing state information satisfies the growing state condition of the growing state update rule Ru, the worker is demanded to observe the crop and the like in accordance with the observation rule Ro according to the pre-observation rule ID, and to input an observation result. When the observation result does not satisfy a condition defined in the observation rule Ro, the update process of the growing state information is not performed.

The work presence or absence indicates a presence or absence of the work indicated by the pre-demanded work. When a value of the work presence or absence indicates a “presence”, the pre-demanded work is conducted. The value of the work presence or absence indicates an “absence”, the pre-demanded work is not conducted. Accordingly, the pre-demanded work is used as a parameter to be validated when the value of the work presence or absence indicates the “presence”. The pre-demanded work corresponds to a work task to be a premise of the update process of the growing state information. That is, if the work task indicated by the pre-demanded work is not performed, the update process of the growing state information is not performed.

The stage goal achievement evaluation value corresponds to a value which is provided with respect to the growing state prior to an update (that is, the growing stage pertinent to the growing state update rule Ru) when the growing stage is updated by applying the growing state update rule Ru.

In step S102, with respect to the crop name, the variety, the cropping type, the cultivation method, the current growing stage, and the lapsed days in the current growth, one or more growing state update rules Ru, which meet the growing state condition defined by parameters from the crop name to the redundant section, is retrieved. In general, multiple growing state update rules Ru, each of which has a different stage goal achievement evaluation value, are retrieved. In other words, the growing state update rules Ru, in which the growing state condition and the additional condition are commonly defined, and the pre-observation rule IDs and the stage goal achievement evaluation values are different, are registered beforehand in the growing state update rule storage part 113.

When no growing state update rule Ru is retrieved (No in step S103), the growing state update process in FIG. 3 is terminated. When the growing state update rule Ru (hereinafter, called “current growing state update rule Ru”) is retrieved (Yes in step S103), the growing state update part 112 determines whether the work presence or absence of the current growing state update rule Ru indicates the “presence” (step S104). In general, multiple current growing state update rules Ru are retrieved. However, the value of the work presence or absence and the value of the pre-demanded work for each of the current growing state update rules Ru are registered to be common. Accordingly, a determination in step S104 may be performed based on any one of the multiple current growing state update rules Ru.

When the value of the work presence or absence indicates the “absence” (No in step S104), the growing state update process advances to step S107. When the work presence or absence indicates the “presence” (Yes in step S104), the growing state update part 112 confirms, by referring to the work history storage part 119, whether the work task indicated by the pre-demanded work is performed relevant to the crop pertinent to the growing state information (step S105).

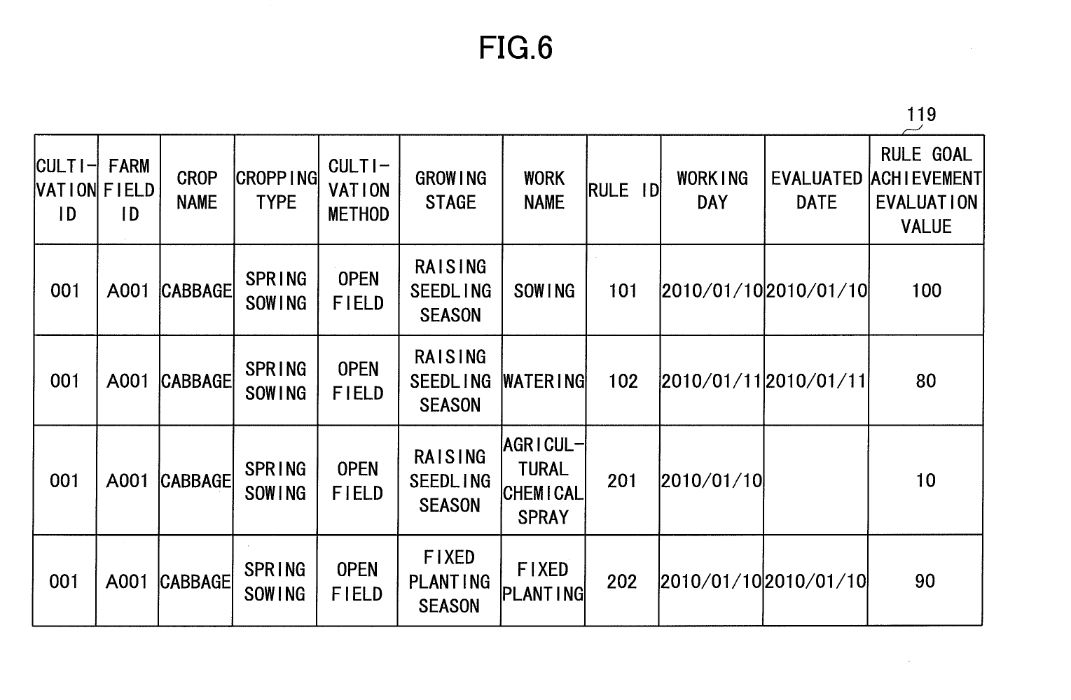

FIG. 6 is a diagram illustrating a configuration example of the work history storage part. In FIG. 6, the work history storage part 119 stores a cultivation ID, a farm field ID, a crop name, a variety, a cropping type, a cultivation method, a growing stage, a work name, a rule ID, a working date, an evaluated date, a rule goal achievement evaluation value, and the like.

The cultivation ID, the farm field ID, the crop name, the variety, the cropping type, the cultivation method, and the growing stage correspond to those stored in the growing state storage part 111 when the work task related to the crop, which is subject for the work task, is performed.

The work name indicates a name of the work task which is performed in accordance with the work rule. The rule ID indicates the rule ID of the work rule causing the work task. The working date indicates a date when the work task is performed (performance date). An evaluated date indicates a date when the rule goal achievement evaluation value, which is related to the work task performed based on the work rule, is input. That is, the evaluated date indicates a date when an evaluation pertinent to the work task is performed. The rule goal achievement evaluation value indicates a value which is input relevant to the work task performed based on the work rule.

As described above, information related to the work task previously performed is stored in the work history storage part 119. In records stored in the work history storage part 119, a process in step S105 confirms a presence or an absence of a record in which the cultivation ID, the farm field ID, the crop name, the cropping type, the cultivation method, and the growing stage match with those of the growing state information, and the work name matches with that indicated by the pre-demanded work of the current growing state update rule Ru.

When there is no record (when the pre-demanded work is not performed) (No in step S106), the growing state update process in FIG. 3 is terminated. When there is one or more records (when the pre-demanded work is performed) (Yes in step S106), the growing state update part 112 retrieves the observation rule Ro having the pre-observation rule ID as the rule ID from the work rule storage part 114 for each of the current growing state update rules Ru (step S107).

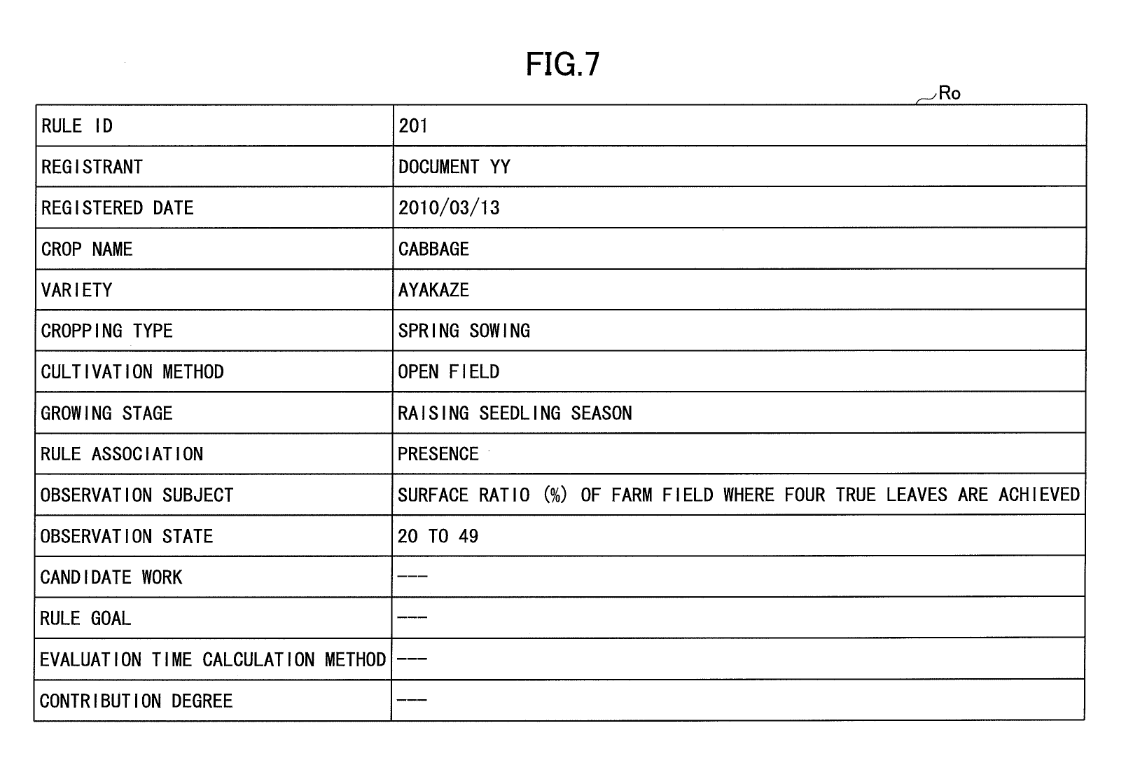

FIG. 7 is a diagram illustrating a configuration example of the observation rule which is referred to by the growing state update rule. In FIG. 7, the observation rule Ro includes items of a rule ID, a registrant, a registered date, a crop name, a variety, a cropping type, a cultivation method, a growing stage, a rule association, an observation state, a candidate work, a rule goal, an evaluation time calculation method, a contribution degree, and the like. The rule ID, the registrant, the registered date, and the like are as described relevant to the growing state update rule Ru (FIG. 5).

The rule association indicates a presence or an absence of an association with the growing state update rule Ru or the growing state rule Rs. For the observation rule Ro, the association is to be referred to from another rule. The observation rule Ro independently forms one work rule. However, the observation rule Ro may be referred to from the growing state update rule Ru or the growing state rule Rs, and may form a part of a rule referring thereto.

An observation subject and the observation state correspond to parameters forming a condition of the observation rule Ro. The observation subject indicates a subject to observe. The observation state indicates a comparison value which is compared with an observation result with respect to the observation subject, for the observation rule Ro to be applied. That is, when a state of the observation subject matches with a state indicated by the observation state, the observation rule Ro is applied.

The items from a candidate state correspond to parameters which become validated when there is no rule association. Accordingly, these parameters are invalid for the observation rule Ro which is referred to by the growing state update rule Ru. Thus, the explanations thereof will be omitted.

The observation rule Ro without the rule association defines the work task to perform when the observation subject is in a state indicated by the observation state. On the other hand, the observation rule Ro (the observation rule Ro with the rule association) which is referred to by another rule is used to determine whether the observation subject is in the state indicated by the observation state. The observation rule Ro indicated in FIG. 7 is used to determine whether a surface ratio of the farm field where four true leaves are achieved falls in 20% to 49%.

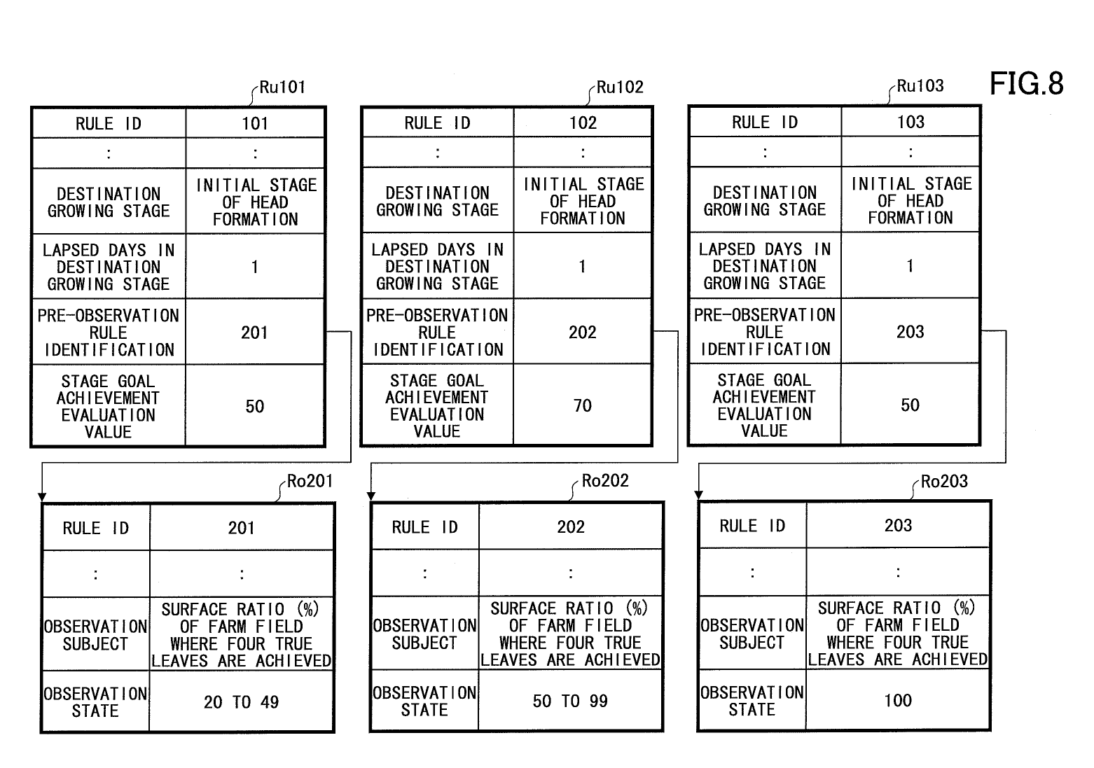

In step S107, the observation rule Ro is retrieved for each of the multiple current growing state update rules Ru. Accordingly, as of the step S107, the growing state update part 112 may include the growing state update rule Ru and the observation rule Ro as indicated in FIG. 8 as process subjects.

FIG. 8 is a diagram illustrating examples of the growing state update rule and the observation rule as the process subjects in the growing state update process.

In FIG. 8, three growing state update rules Ru101 through Ru103 and observation rules Ro201 through Ro203 referred to by any of the growing state update rules Ru101 through Ru103 are illustrated. In each of the growing state update rules Ru101 through Ru103 and each of the observation rules Ro201 through Ro203 in FIG. 8, only items relevant to the embodiment are depicted.

The following three points are remarkable. First, the stage goal achievement evaluation value is different for each of the growing state update rules Ru101 through Ru103. Second, the observation subject for each of the observation rules Ro201 through Ro203 is common. Third, the observation state is different for each of the observation rules Ro201 through Ro203.

Regarding a first point, the stage goal achievement evaluation values indicate “50”, “70”, and “100” for the growing state update rules Ru101 through Ru103, respectively. Regarding a second point, the observation subject for each of the observation rules Ro201 through Ro203 indicates that “SURFACE RATIO (%) OF FARM FIELD WHERE FOUR TRUE LEAVES ARE ACHIEVED”. Regarding a third point, the observation states indicate “20-49”, “50-99”, and “100” for the observation rules Ro201 through Ro203, respectively.

Next, the growing state update part 112 displays an instruction at the display device 106 based on the observation subject and the observation state included in a retrieved observation rule Ro (step S108). The instruction indicates for the worker to observe whether the observation subject is in the observation state. A screen (hereinafter, called “observation instruction screen”) including a message indicating the instruction may be displayed. In a case of the observation rules Ro201 through Ro203 illustrated in FIG. 8, the message to instruct an observation of the surface ratio of the farm field where four true leaves are achieved is displayed at the observation instruction screen.

Next, the observation result input part 121 receives an input of the observation result from the worker who observes the observation subject (step S109). The input of the observation result may be performed through an observation result input screen which the observation result input part 121 displays at the display device 106.

In a case of the observation rule Ro illustrated in FIG. 8, the observation result input screen may include a letter string input component for the worker to input information indicating the surface ratio of the farm field where four true leaves are achieved. Alternatively, the observation result input screen may include checkboxes including four alternatives corresponding to three values of the observation states for three observation rules Ro201 through Ro203 and another value indicating non-relevant to any of the observation states of three observation rules Ro201 through Ro203. Further, a screen for the worker to select whether the observation result is relevant to the observation state (“YES”) or not (“NO”) may be displayed for each of the observation rules Ro201 through Ro203.

In any pattern, values comparable with the observation results of the observation rules Ro201 through Ro203 may be input as the observation results.

Next, the observation result input part 121 determines the presence or absence of the observation rule Ro including the observation state which matches with the input observation result (step S110). It is determined that the input observation result matches with one of the observation states of three observation rules Ro201 through Ro203 in FIG. 8. When none of three observation rules Ro201 through Ro203 do matches with the observation result (NO in step S110), the observation result input part 121 terminates the growing state update process in FIG. 3. Accordingly, in this case, the growing state information based on the growing state update rule Ru is not updated. In a case in FIG. 8, if the surface ratio of the farm field where four true leaves are achieved indicates less than 20%, the growing state information is not updated.

On the other hand, when there is the observation rule Ro matching with the observation result (YES in step S110), the growing state update part 112 updates the growing state information in accordance with the current growing state update rule Ru referring to the observation rule Ro, which matches with the observation result, in response to a request from the observation result input part 121 (step S111). In a case in FIG. 8, even if the observation result matches with any one of the observation rules Ro201 through Ro203, the current growing stage of the growing state information (FIG. 4) is updated to an “initial stage of a head formation”, and the lapsed days in the current growth is updated to “1”.

Moreover, the current growing stage start date of the growing state information is updated to a current date. Furthermore, when the current growing stage of the growing state information is different between before and after the update, the growing stage start date and the growing stage end date pertaining to the current growing stage before the update is added to the growing state information. The current growing stage start date before the update is transcribed to the growing stage start date. The current date is recorded to the growing stage end date.

The lapsed days (the lapsed days in the current growth) of a new growing stage is set to be different depending on the observation result. If the surface ratio of the farm field where four true leaves are achieved falls in 50% to 99%, the lapsed days may be set to “2”. If the surface ratio indicates 100%, the lapsed days may be set to “5”. In this case, values of the lapsed days in destination growing stage may be set to “2” and “5” for the growing state update rules Ru102 and Ru103, respectively.

As described above, by changing the lapsed days in the new growing stage depending on the observation result, it is possible to further approximate contents of the growing state information to an actual growing state of the crop.

Next, the observation result input part 121 determines whether the value of the current growing stage of the growing state information changes by a process in step S111 (step S112). When the value of the current growing stage of the growing state information does not change (NO in step S112), the observation result input part 121 terminates the growing state update process in FIG. 3. In general, the growing state update rule Ru is applied to update the growing stage. The growing state update rule Ru has been already applied as at step S112. Even if the growing state update rule Ru has been already applied, a determination in step S112 is conducted, since it is possible to utilize the growing state update rule Ru for other than the update of the growing stage. This will be described later.

On the other hand, when the value of the current growing stage of the growing state information is changed (YES in step S112), the observation result input part 121 records one record (the growing stage information) pertinent to a completed growing stage (the growing stage before the update) to the growing stage history storage part 122 (step S113). Then, the growing state update process is terminated.

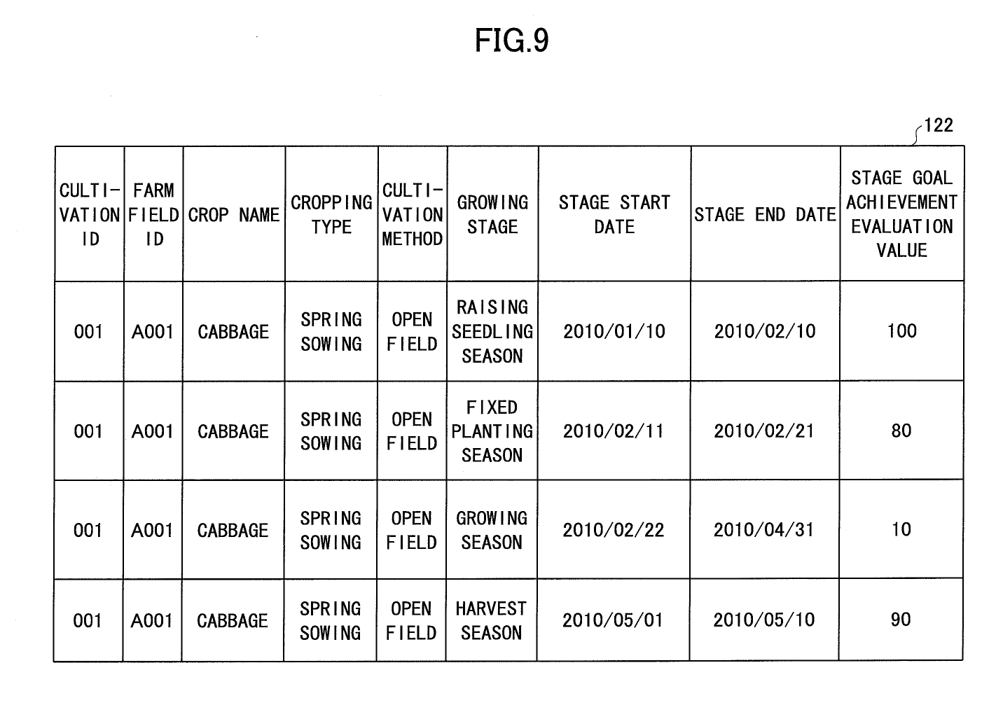

FIG. 9 is a diagram illustrating a configuration example of the growing stage history storage part 122. In FIG. 9, the growing stage history storage part 122 stores a cultivation ID, a farm field ID, a crop name, a cropping type, a cultivation method, a growing stage, a stage start date, a stage end date, a stage goal achievement evaluation value, and the like for each of previous growing stages.

The cultivation ID, the farm field ID, the crop name, the cropping type, and the cultivation method of the growing state information are recorded to respective items of a newly added record. A value of the current growing stage before the update is recorded as the growing stage. The “growing stage start date” and the “growing stage end date”, which are added to the growing state information in the last instance (that is, latest “growing stage start date” and “growing stage end date”), are recorded as the growing stage start date and the growing state information of the newly added record. The stage goal achievement evaluation value, which is included in the growing state update rule Ru applied in step S111, is recorded as the stage goal achievement evaluation value of the newly added record. Accordingly, when the growing state update rule Ru101 is applied illustrated in FIG. 8, “50” is recorded as the stage goal achievement evaluation value of the growing stage history storage part 122. When the growing state update rule Ru102 is applied, “70” as recorded to the stage goal achievement evaluation value of the growing stage history storage part 122. When the growing state update rule Ru103 is applied, “100” is recorded as the stage goal achievement evaluation value of the growing stage history storage part 122.

The growing state update rule Ru to be applied is selected based on the actual observation result. That is, the growing stage goal achievement evaluation value is recorded based on the actual observation result (that is, the growing state). Thus, an input of the observation result practically corresponds to an input of the stage goal achievement evaluation value.

The example of updating the growing stage depending on the growing state (a growing progress) is described above. The growing stage, which ends by a predetermined work task, is also defined. That is, the “growing stage” may include sense of a “work stage”, since what growing stage is arbitrarily defined based on an operation.

It is assumed that a “cabbage preparation season” is defined as the growing stage for a phase of soil preparation. In this case, the “cabbage preparation season” ends when the soil preparation ends.

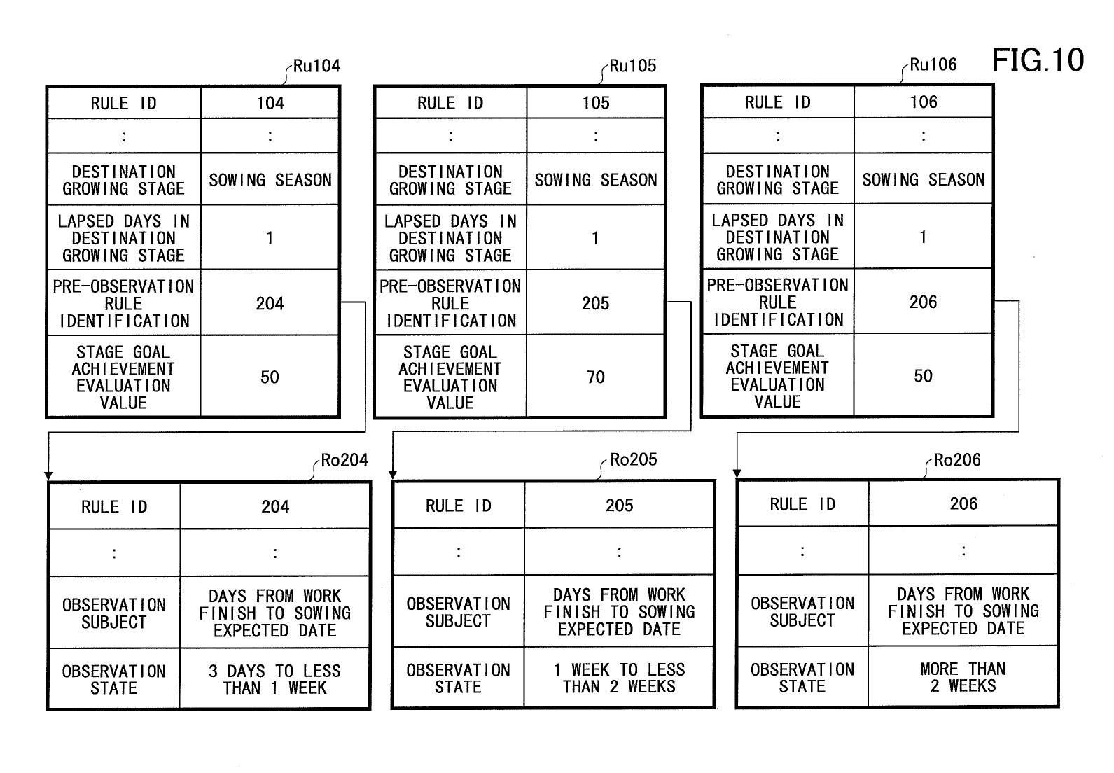

Regarding the growing stage which ends by performing the predetermined work task, the process procedure described in FIG. 3 is available. In this case, the growing state update rule Ru and the observation rule Ro may be defined as illustrated in FIG. 10.

FIG. 10 is a diagram illustrating examples of the growing state update rule Ru and the observation rule Ro related to the growing stage which ends when the work task is completed. The examples in FIG. 10 depict the growing state update rules Ru104 through Ru106 and the observation rules Ro204 through Ro206 in the same format as those in FIG. 8. Each of the growing stage update rule Ru104 through Ru106 is applied to the “cabbage preparation season” (that is, the value of the growing stage indicates the “cabbage preparation season”), and is used to update the growing stage to a “sowing season”. Also, the observation subject for the observation rules Ro204 through Ro206 referred to by the growing state update rules Ru104 through Ru106 respectively is set in common as “days from a work end to an expected sowing date”. In the embodiment, the “days from a work end to an expected sowing date” is set as the observation subject for the “cabbage preparation season”, since it is preferable to make a certain interval of days from an end of the soil preparation to the sowing. Although being omitted in FIG. 10, “soil preparation” may be set as the pre-demanded work for each of the growing state update rules Ru104 through Ru106. That is, a name of the work task, in which the end of the work task corresponds to the end of the growing stage, is set to the pre-demanded work.

The observation state of the observation rule Ro204 indicates “3 days to less than 1 week”. The observation state of the observation rule Ro205 indicates “1 to less than 2 weeks”. The observation state of the observation rule Ro206 indicates “more than 2 weeks”.

Accordingly, by setting the growing state update rules Ru and the observation rules Ro as illustrated in FIG. 10 as the process subjects, it is possible to change the stage goal achievement evaluation value based on a time when the soil preparation ends. By generalizing, related to the growing stage which ends when the work task ends, it is possible to change the stage goal achievement evaluation value based on a result of the work task.

In the examples in FIG. 10, when days from the end of the soil preparation to the expected sowing date are less than 3 days, the update of the growing stage is not conducted.

In the above, the growing state update rule Ru may be used for a purpose other than the update of the growing stage. This point will be described.

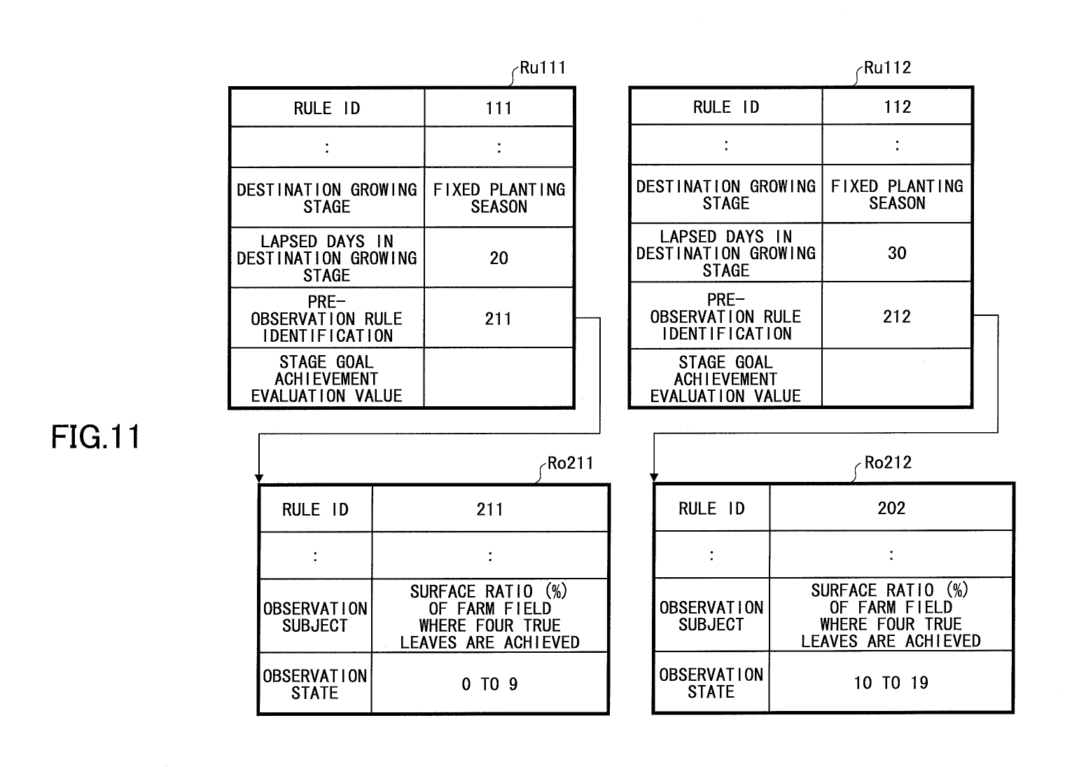

In the embodiment, the growing state update part 112 periodically adds one to the lapsed days (step S101 in FIG. 3). However, the actual growing state of the crop does not always correspond to the lapsed days. Specifically, the growth may be delayed compared with the actual lapsed days. The growing state update rule Ru may be used as a correction part for a growth delay. In this case, the growing state update rules Ru and the like depicted in FIG. 11 may be added to the growing state update rules Ru101 through Ru103 and the like depicted in FIG. 8.

FIG. 11 is a diagram illustrating examples of the growing state update rules and the observation rules used to correct the growing state information depending on the actual growing state.

The growing state update rules Rulll and Ru112 illustrated in FIG. 11 are regarded as the process subjects during 35 days to 45 days which are the lapsed days in the fixed planting season, similar to the growing state update rules Ru depicted in FIG. 5. However, the destination growing stages of the two growing state update rules Rulll and Ru112 in FIG. 11 indicate the “FIXING PLANTING SEASON” similar to the current growing stage. Moreover, the lapsed days in the destination growing stage indicate “20” or “30” which is a value less than 35 days to 45 days (that is, a value indicating the growing state (the lapsed days) prior to the growing state meeting the growing state condition). These growing state update rules Rulll and Ru112 are not used to trigger the update of the growing stage. Thus, the stage goal achievement evaluation values thereof indicate blank or invalid.

The observation subject of the observation rules Ro211 and Ro212, which are referred to by the growing state update rules Rulll and Ru112, respectively, indicate “SURFACE RATIO (%) OF FARM FIELD WHERE FOUR TRUE LEAVES ARE ACHIEVED” similar to those in FIG. 5 or FIG. 8. The observation state of the observation rule Ro211 indicates “0 TO 9”. The observation state of the observation rule Ro212 indicates “10 TO 19”.

As at step S108 in FIG. 3, it is considered that the growing state update rules Rulll and Ru112 and the like illustrated in FIG. 11 are the process subject in addition to the growing state update rules Ru101 through Ru103 and the like illustrated in FIG. 8. In this case, in step S108, when a value indicating 0% to 9% is the observation result, the growing state update rule Rulll in FIG. 11 is applied. As a result, in step S111, the current growing stage of the growing state information is not updated, and the lapsed days in the current growth is set back to “20”.

As described above, depending on the observation result, based on the growing state update rule Ru111, the growing state information may be updated in an opposite direction to a growing direction. Accordingly, a value of the lapsed days in the current growth in the growing state information, which is periodically updated, may be corrected to further approximate the actual growing state.

Next, a first extraction process of the work rule, which is regarded as an application candidate depending on the growing state indicated by the growing state information managed as described above, other factors, or the like, will be described.

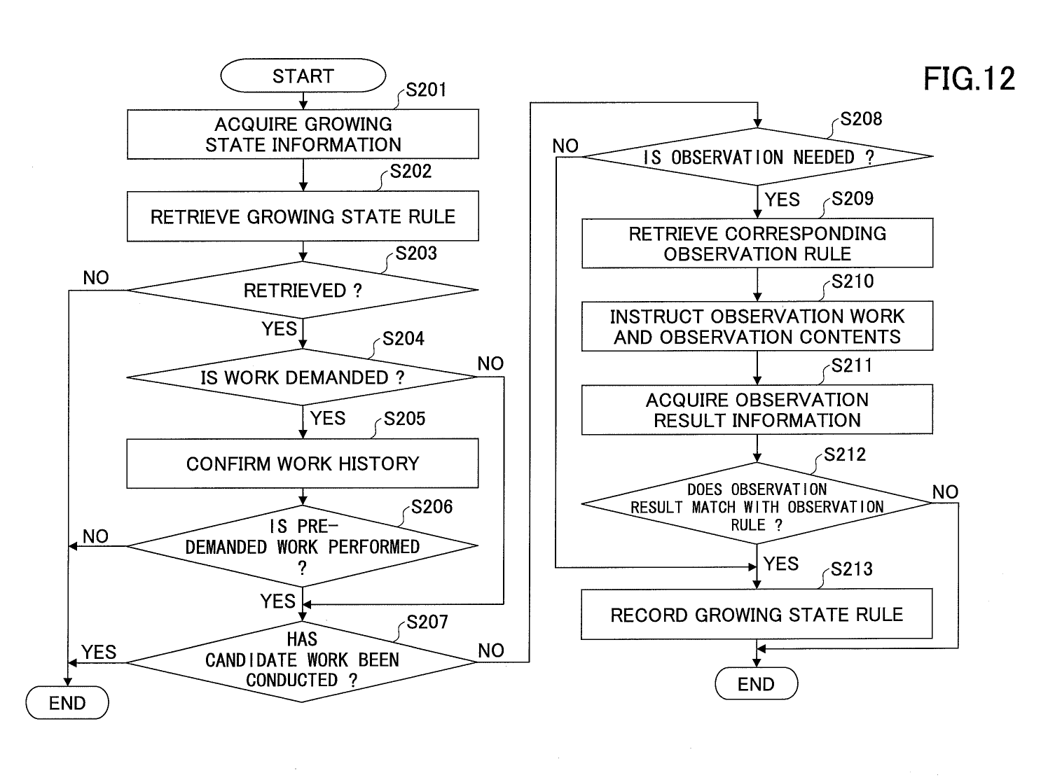

First, the first extraction process of the work rule depending on the growing state will be described. FIG. 12 is a flowchart for explaining an example of a process procedure of the first extraction process of the work rule depending on the growing state. The first extraction process in FIG. 12 is periodically executed. The first extraction process may be executed after the growing state information is updated by the growing state update part 112.

In step S201, the work rule extraction part 115 acquires the growing state information (FIG. 4) from the growing state storage part 111. The process procedure in FIG. 12 is executed for each set of the growing state information stored in the growing state storage part 111. For convenience, one set of the growing state information is focused on and the process procedure is described.

Next, the work rule extraction part 115 retrieves the growing state rule Rs including the growing state condition matching with the growing state information, from the growing state rule Rs stored in the work rule storage part 114 (step S202).

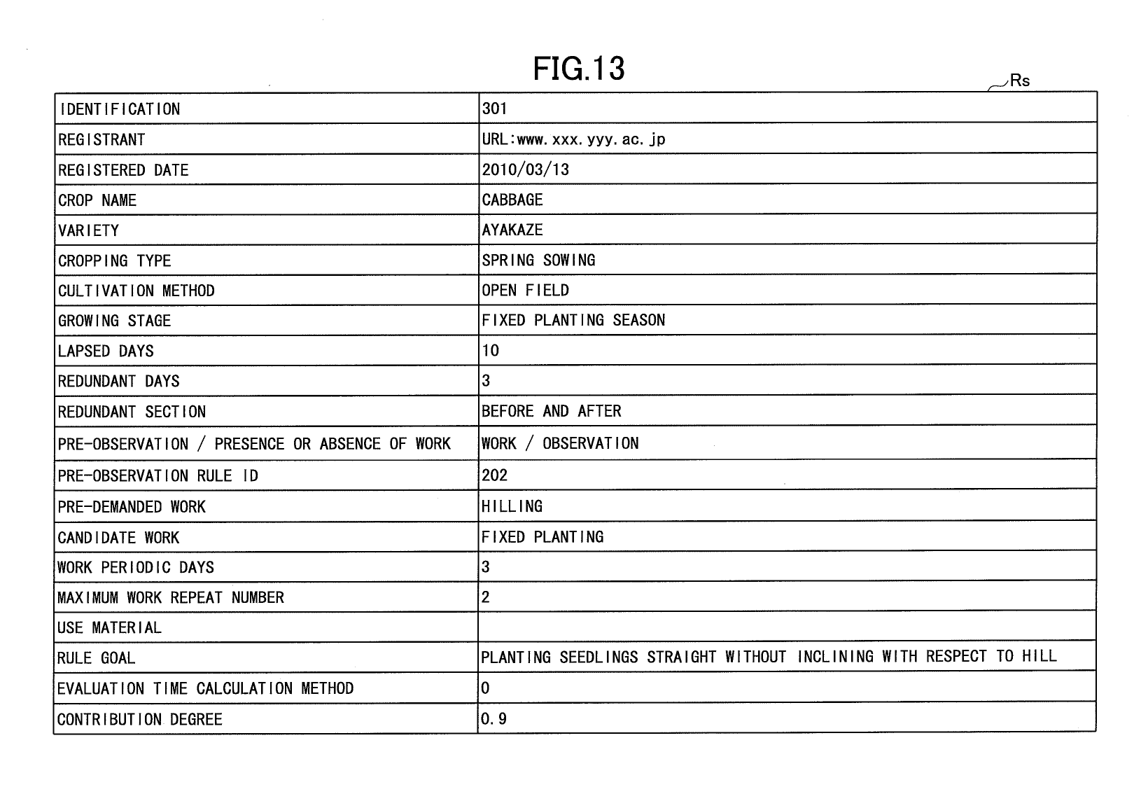

FIG. 13 is a diagram illustrating a configuration example of the growing state rule Rs. The growing state rule Rs is regarded as the work rule which defines a condition for the growing state of the crop and the work task to conduct when the condition is satisfied. In FIG. 13, the growing state rule Rs includes items of a rule ID, a registrant, a registered date, a crop name, a variety, a cropping type, a cultivation method, a growing stage, lapsed days, redundant days, a redundant section, a pre-observation/work presence or absence, a pre-observation rule ID, a pre-demanded work, a candidate work, a work periodic days, a maximum work repeat number, a use material, a rule goal, an evaluation time calculation method, a contribution degree, and the like.

The rule ID, the registrant, and the registered date are the same as those previously described for the growing state update rule Ru (FIG. 5) and the like.

In the growing state rule Rs, the items from the crop name to the redundant section correspond to parameters forming the condition (the growing state condition) for the growing state information. The parameters are the same as those previously described related to the growing state update rule Ru.

The pre-observation/work presence or absence, the pre-observation rule ID, and the pre-demanded work indicate additional conditions to the growing state condition. That is, the pre-observation/work presence or absence corresponds to a parameter which indicates whether the pre-observation or a predetermined work task is demanded for the growing state rule Rs to be applied. A value of the pre-observation/work presence or absence indicates one of “NONE”, “OBSERVATION”, “WORK”, or “OBSERVATION/WORK”. “NONE” indicates that both the observation and the work task are not demanded. “OBSERVATION” indicates that the observation alone is demanded. “WORK” indicates that the work task alone is demanded. “OBSERVATION/WORK” indicates that both the observation and the work task are demanded.

The pre-observation rule ID and the pre-demanded work are the same as those described related to the growing state update rule Ru. That is, the growing state rule Rs may also refer to the observation rule Ro. However, the pre-observation rule ID is validated when the value of the pre-observation/work presence or absence indicates “OBSERVATION” or “OBSERVATION/WORK”. Moreover, the pre-demanded work is validated when the value of the pre-observation/work presence or absence indicates “OBSERVATION” or “OBSERVATION/WORK”.

The candidate work, the work periodic days, and the maximum work repeat number are regarded as parameters pertinent to the work task to perform when the growing state condition and the additional condition of the growing state rule Rs.

The candidate work corresponds to the name of the work task to perform. In a case of competing with other work rules, the candidate work is not always selected as the work task to perform. Thus, a word “candidate” is prefixed to a word “work”. The work periodic days indicate a period in a case in which the candidate work is periodically demanded. The maximum work repeat number indicates an upper limit of repetition in a case in which the candidate work is demanded to be periodically performed.

The use material is a material used in the work task indicated by the candidate work. When the candidate work indicates an agricultural chemical spray, the pesticide name is set. In the embodiment, the use material is referred to in determining the evaluation time.

The rule goal corresponds to a goal of the work task which is performed based on the growing state rule Rs or a goal of the growing state rule Rs. The evaluation time calculation method indicates a calculation method of the evaluation time of an achievement degree (the rule goal achievement evaluation value) of the rule goal on the basis of the execution date of the work task. If a numeric value is set in the evaluation time calculation method, the evaluation time is calculated by adding days indicated by the numeric value. On the other hand, when the numeric value is set in the evaluation time calculation method, the evaluation time is calculated by another method. In the configuration example in FIG. 13, “0” is set. Thus, this value indicates that a day when the candidate work “fixing planting season” is performed is the evaluation time of the rule goal of “PLANTING SEEDLINGS STRAIGHT WITHOUT INCLINING WITH RESPECT TO HILL”.

The contribution degree indicates a degree or a rate in which the growing state rule Rs contributes for the stage goal of the growing stage which the work rule (the growing state rule Rs in this case) is applied. That is, the contribution degree may correspond to the degree or the rate in which the work rule contributes to the growth of the crop.

In step S202, the growing state rule Rs, which corresponds to the growing state condition defined by the parameters from the crop name to the redundant section with respect to the crop name, the variety, the cropping type, the cultivation method, the current growing stage, and the lapsed days in the current growth of the growing state information, is retrieved.

When the growing state rule Rs is not retrieved (NO in step S203), the first extraction process of the work rule in FIG. 12 is terminated. When the growing state rule Rs (hereinafter, called “current growing state rule Rs”) is retrieved (YES in step S203), the work rule extraction part 115 determines whether the value of the pre-observation/work presence or absence of the current growing state rule Rs indicates “WORK” or “OBSERVATION/WORK” (step S204). That is, it is determined that the pre-demanded work is indicated.

When the value of the pre-observation/work presence or absence does not indicate “WORK” or “OBSERVATION/WORK” (NO in step S204), the first extraction process advances to step S207. When the value of the pre-observation/work presence or absence indicate WORK” or “OBSERVATION/WORK” (YES in step S204), the work rule extraction part 115 confirms, by referring to the work history storage part 119 (FIG. 6), whether the work indicated by the pre-demanded work task has been already performed (step S205). Contents in step S205 are the same as those in step S105 in FIG. 3. That is, it is confirmed in records stored in the work history storage part 119 whether there is one or more records in which the cultivation ID, the farm field ID, the crop name, the cropping type, the cultivation method, and the growing stage of the record correspond to those of the growing state information, and the work name corresponds to that indicated by the pre-demanded work task.

When there is no record (when the pre-demanded work task is not performed) (NO in step S206), the first extraction process in FIG. 12 is terminated. When there is one or more records (when the pre-demanded work task is performed) (YES in step S206), the work rule extraction part 115 refers to the work history storage part 119 and determines whether the work task, which is indicated by the candidate work of the current growing state rule Rs, is completed (step S207). That is, it is determined whether there is one or more records in which the rule ID, the cultivation ID, the farm field ID, the crop name, the cropping type, the cultivation method, the growing stage, and the candidate work of the record corresponds to those of the current growing state rule Rs.

When the work periodic days and the maximum work repeat number are indicated to the current growing state rule Rs, it is also determined whether an interval among the work days of the records corresponds to the work periodic days and whether a number of the records reaches the maximum work repeat number. That is, in step S207, when the work task indicated by the candidate work has conducted for the maximum work repeat number at a period indicated by the work periodic days in the current growing stage based on the current growing state rule Rs, it is determined that the candidate work is completed.

When the candidate work is completed (YES in step S207), the first extraction process in FIG. 12 ends. Thus, it is possible to avoid redundantly applying the same growing state rule Rs for the same crop.

When the candidate work is not complete (NO in step S207), the work rule extraction part 115 determines whether the value of the pre-observation/work presence or absence of the current growing state rule Rs indicates “OBSERVATION” or “OBSERVATION/WORK”.

When the value of the pre-observation/work presence or absence of the current growing state rule Rs does not indicate “OBSERVATION” or “OBSERVATION/WORK” (NO in step S208), the first extraction process advances to step S213. When the value of the pre-observation/work presence or absence of the current growing state rule Rs indicates “OBSERVATION” or “OBSERVATION/WORK” (YES in step S208), the work rule extraction part 115 retrieves the observation rule Ro (FIG. 7), which includes the pre-observation rule ID of the current growing state rule Rs as the rule ID, from the work rule storage part 114 (step S209).

Next, the work rule extraction part 115 displays an instruction to make the worker observe whether the observation subject is in the observation state based on the observation subject and the observation state included in the retrieved observation rule Ro, at the display device 106 (step S210). Next, the work rule extraction part 115 receives the input of the observation result from the worker who observes the observation subject (step S211).

Next, the work rule extraction part 115 determines whether the input observation result matches with the observation state of the observation rule Ro (step S212). When the observation result matches with the observation rule Ro (YES in step S212), the work rule extraction part 115 records the current growing state rule Rs to the extraction rule storage part 116 (step S213). That is, the current growing state rule Rs is extracted as the application candidate.

When the observation result does not match with the observation rule Ro (NO in step S212), the current growing state rule Rs is not recorded in the extraction rule storage part 116. Then, the first extraction process is terminated.

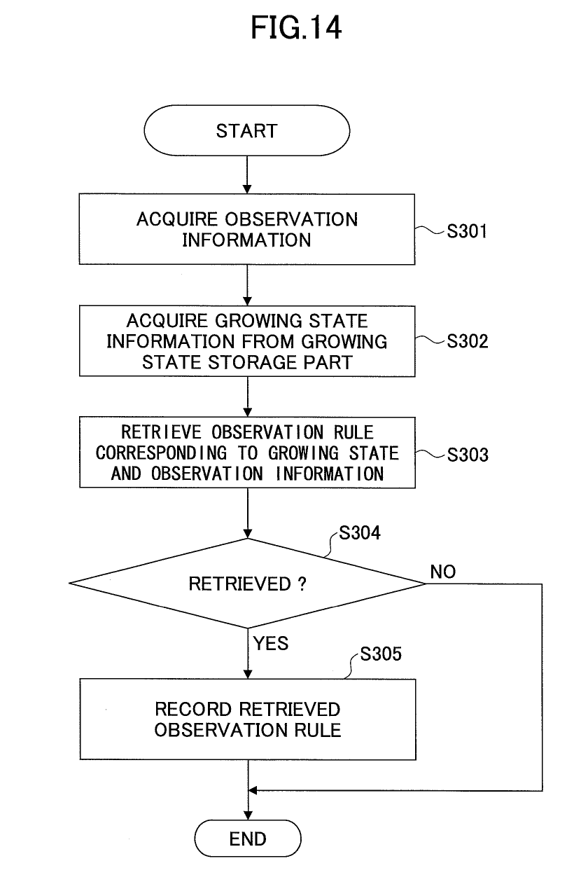

Next, a second extraction process of the work rule depending on observation information will be described. FIG. 14 is a flowchart for explaining an example of a process procedure of the second extraction process of the work rule depending on the observation information.

In step S301, the work rule extraction part 115 acquires the observation information (the observation subject and the observation state). The observation information is not limited to the observation information which is acquired by an observation conducted based on the instruction output by executing the growing state update process in FIG. 3 or the extraction process in FIG. 12. That is, the observation information includes the observation information acquired by the observation when the worker conducts the observation during an agricultural work task in addition to the instruction of the observation rule Ro referred to by the growing state update rule Ru or the observation rule Ro referred to by the growing state rule Rs.

The observation information, which is to be acquired in step S301, may be acquired by making the worker input the observation subject and the observation state through the observation result input screen displayed by the work rule extraction part 115. Alternatively, the observation subject and the observation state, which are input asynchronously with the second extraction process in FIG. 14 and stored in the auxiliary storage device 102, may be acquired. A former method may be suitable in a case of conducting the second extraction process in FIG. 14 in response to the input of the observation information. A latter method may be suitable in a case of periodically conducting the extraction process in FIG. 14.

Next, the work rule extraction part 115 acquires the growing state information from the growing state storage part 111 (step S302). The process procedure from step S302 is conducted for each set of the growing state information stored in the growing state storage part 111. For convenience, one set of the growing state information is focused on and the process procedure is described.

Next, the work rule extraction part 115 retrieves the observation rule Ro, which includes the condition corresponding to the growing state information and the observation information (step S303).

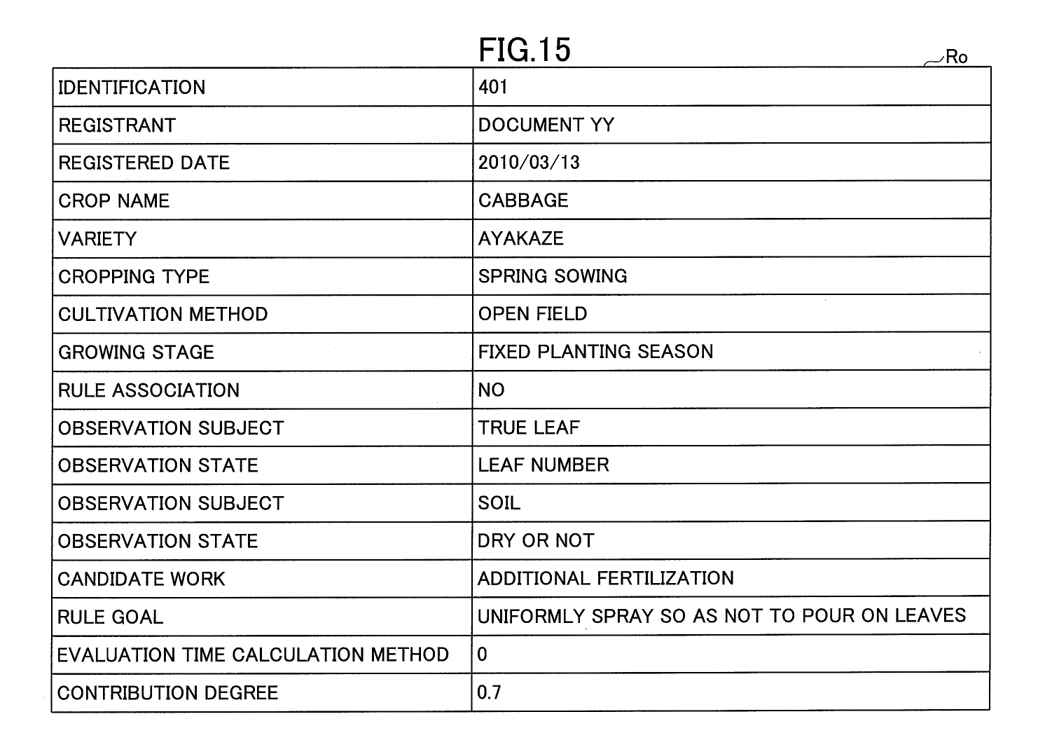

FIG. 15 is a diagram illustrating a configuration example of the observation rule as the work rule. The observation rule as the work rule is not the observation rule Ro (in FIG. 7, for example) referred to by another rule but independently forms one work rule. In the following, in a case in which the observation rule Ro related to a description of FIG. 14 is referred to, the observation rule Ro is indicated as the work rule.

The observation rule Ro is regarded as the work rule which defines the condition for the growing state of the crop or the observation information pertinent to the crop or the farm field (the soil and the like), and the work task to perform when the condition is satisfied. Each of parameters illustrated in FIG. 15 is as described with reference to FIG. 7. That is, in the embodiment, there is no difference related to a configuration between the observation rule Ro as the work rule and the observation rule Ro referred to by another rule. A value of the rule association of the observation rule Ro as the work rule indicates “NO”. Moreover, in the observation rule Ro as the work rule, the candidate work, the rule goal, the evaluation time calculation method, and the contribution degree may be effective parameters. These parameters are as described related to the growing state rule Rs in FIG. 13.

The observation rule Ro in FIG. 15 includes two pairs of the observation subject and the observation state. In this manner, the observation rule Ro may include two pairs of the observation subject and the observation state. In a case in which multiple pairs of the observation subject and the observation state are included, a presence or absence of fulfillment of the condition is evaluated by a logical product (AND) for each pair. Similarly, the observation rule Ro referred to by another rule may include multiple pairs of the observation subject and the observation state.

In step S303, the observation rule Ro, of which the items from the crop name to the growing stage correspond to those of the growing state information and the observation subject and the observation state correspond to those of the observation information, is retrieved.

When the observation rule Ro is not retrieved (NO in step S304), the second extraction process in FIG. 14 is terminated. When the observation rule Ro is retrieved (YES in step S304), the work rule extraction part 115 records the retrieved observation rule Ro in the extraction rule storage part 116 (step S305). That is, the observation rule Ro is extracted as the application candidate.

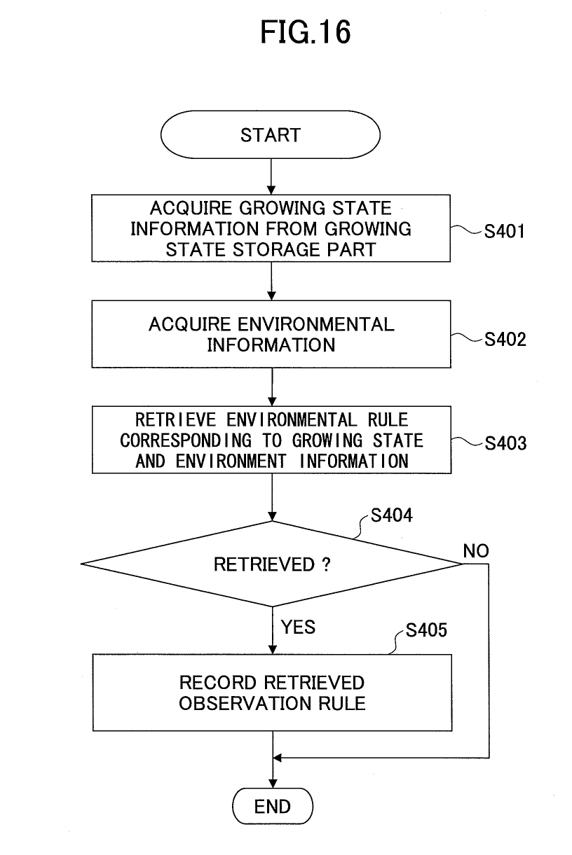

Next, a third extraction process of the work rule depending on the environmental information will be described. FIG. 16 is a flowchart for explaining an example of a process procedure of the third extraction process of the work rule depending on the environmental information. The third extraction process in FIG. 16 is periodically conducted.

In step S401, the work rule extraction part 115 acquires the growing state information from the growing state storage part 111. The process procedure from step S401 is performed for each set of the growing state information stored in the growing state storage part 111. For convenience, one set of the growing state information is focused on and the process procedure is described.

Next, the work rule extraction part 115 acquires the environmental information from the environmental information storage part 127 (step S402).

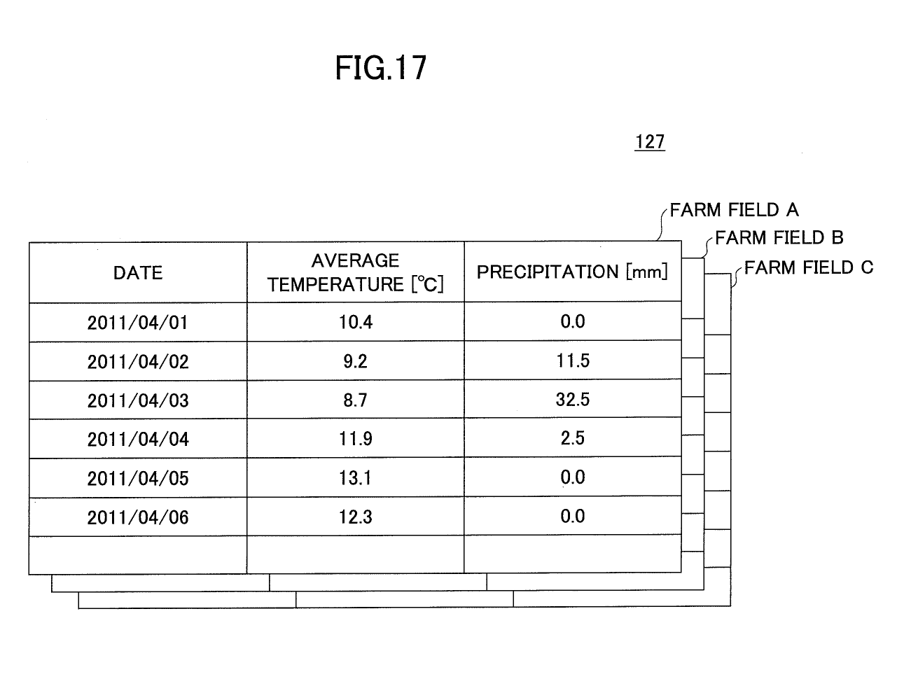

FIG. 17 is a diagram illustrating a configuration example of the environmental information storage part 127. In FIG. 17, the environmental information storage part 127 stores a history of the meteorological information of an average temperature per day, precipitation per day, and the like for each of farm fields (for each of farm field IDs). However, the environmental information storage part 127 may store other parameters such as sunshine duration, humidity, and the like.

In step S402, the work rule extraction part 115 acquires the environmental information with respect to the farm field ID recorded in the growing state information from the environmental information storage part 127.

Next, the work rule extraction part 115 retrieves the environmental rule Re including the condition matching with the growing state information and the environmental information from the work rule storage part 114 (step S403).

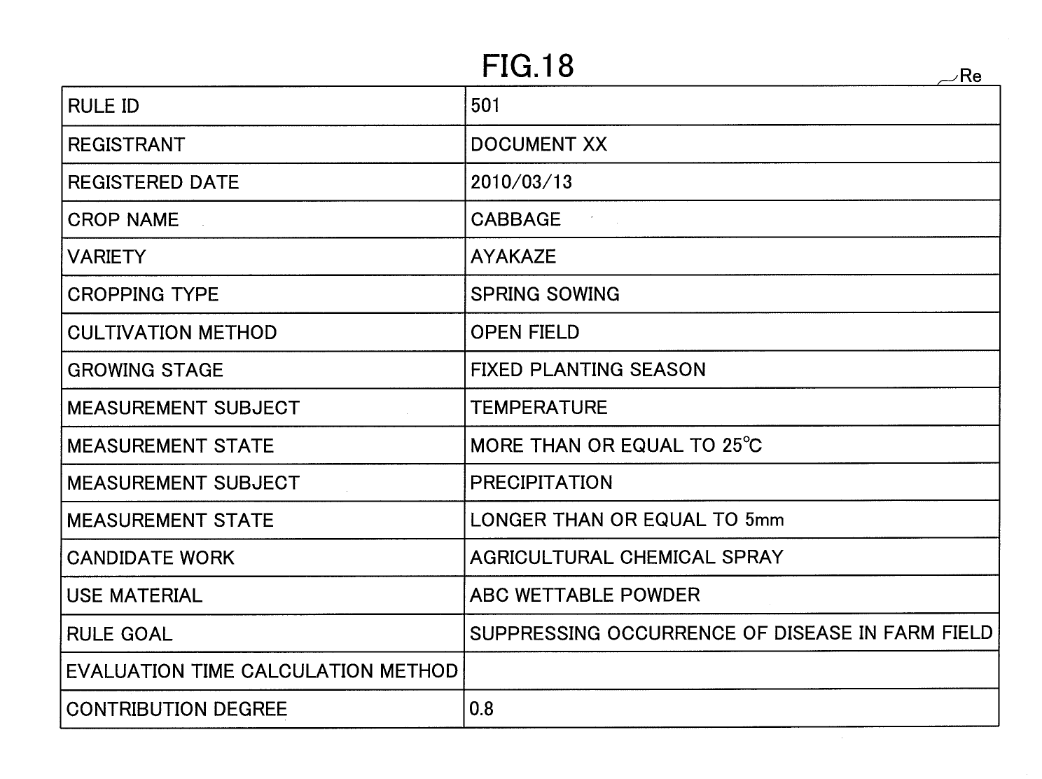

FIG. 18 is a diagram illustrating a configuration example of the environmental rule Re. The environmental rule Re is regarded as the work rule which defines the condition with respect to the growing state of the crop and the environment of the farm field and the work task which is performed when the condition is satisfied. In FIG. 18, the environmental rule Re includes items of a rule ID, a registrant, a registered date, a crop name, a variety, a cropping type, a cultivation method, a growing stage, a measurement subject, a measurement state, a candidate work, a rule goal, an evaluation time calculation method, a contribution degree, and the like. The rule ID, the registrant, the registered date, and the like are as described related to the growing state update rule Ru (FIG. 5) and the like.

The items from the crop name to the growing stage correspond to parameters forming the condition (growing state condition) with respect to the growing state information.

A pair of the measurement subject and the measurement state is regarded as a parameter forming the condition (environmental condition) with respect to the environmental information in the environmental rule Re. The measurement subject indicates a subject (the temperature, the precipitation, the humidity, and the like) to measure by a measuring device. The measurement state indicates a measurement value of the measurement subject or a result of processing the measurement value.

The environmental rule Re in FIG. 18 includes two pairs of the measurement subject and the measurement state. Thus, the environmental rule Re may include two pairs or more than two pairs of the measurement subject and the measurement state. In a case in which multiple pairs of the measurement subject and the measurement state are included, a presence or absence of fulfillment of the condition is evaluated by a logical product (AND) for each pair.

Moreover, in the environmental rule Re in FIG. 18, there is no data for the evaluation time calculation method. This indicates that the evaluation time of the rule goal, which indicates “SUPPRESSING OCCURRENCE OF DISEASE IN FARM FIELD” after the candidate work of “AGRICULTURAL CHEMICAL SPRAY” is performed, is not fixed. In other words, this indicates that the evaluation time is dynamically calculated depending on a pesticide valid term.

In step S403, the environmental rule Re, which matches with the items from the crop name to the growing stage with respect to the growing state information, and matches with the items the measurement subject and the measurement state with respect to the environmental information, is retrieved.

When the environment rule Re is not retrieved (NO in step S404), the third extraction process in FIG. 16 is terminated. When the environmental rule Re is retrieved (YES in step S404), the work rule extraction part 115 records the retrieved environmental rule Re to the extraction rule storage part 116 (step S405). That is, the environmental rule Re is extracted as the application candidate. Then, the third extraction process is terminated.

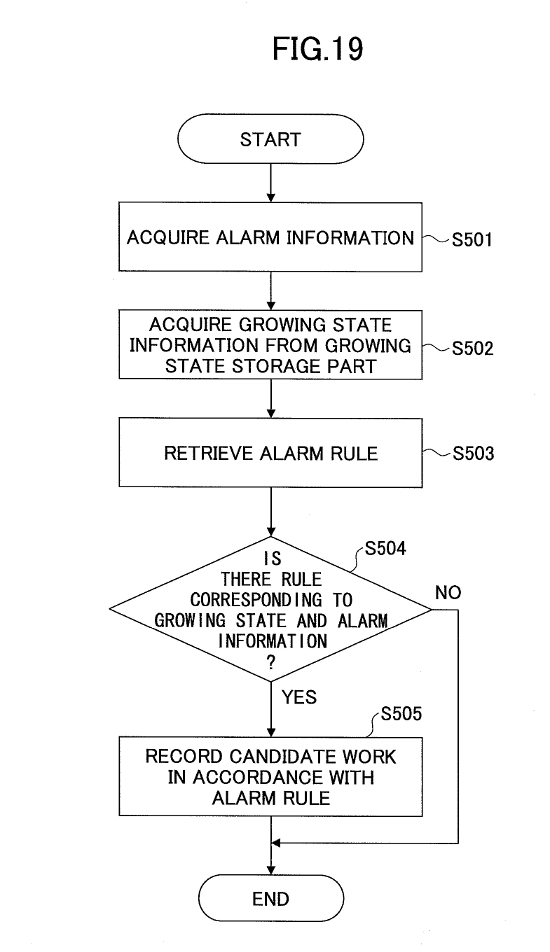

Next, a fourth extraction process of the work rule depending on the alarm information will be described. FIG. 19 is a flowchart for explaining an example of a process procedure of the fourth extraction process of the work rule depending on the alarm information. The fourth extraction process in FIG. 19 may be periodically executed.

In step S501, the work rule extraction part 115 acquires the alarm information from the auxiliary storage device 102. The alarm information may indicate one set of various information (such as typhoon information, pest occurrence prediction, and the like) which a weather information service company, an agricultural experimental facility, or the like non-periodically provides. The alarm information is recorded in the auxiliary storage device 102 based on information provided from a provider. Recording the information in the auxiliary storage device 102 may be automatically performed by connecting the provider with the agricultural work support apparatus 10 through the network, or may be performed by manually inputting the information.

Next, the work rule extraction part 115 acquires the growing state information from the growing state storage part 111 (step S502). The process procedure after step S502 is executed for each set of the growing state information stored in the growing state storage part 111. For convenience, one set of the growing state information is focused on and the process procedure is described.

Next, the work rule extraction part 115 retrieves the alarm rule Rw including the condition matching with the growing state information and the alarm information from the work rule storage part 114 (step S503).

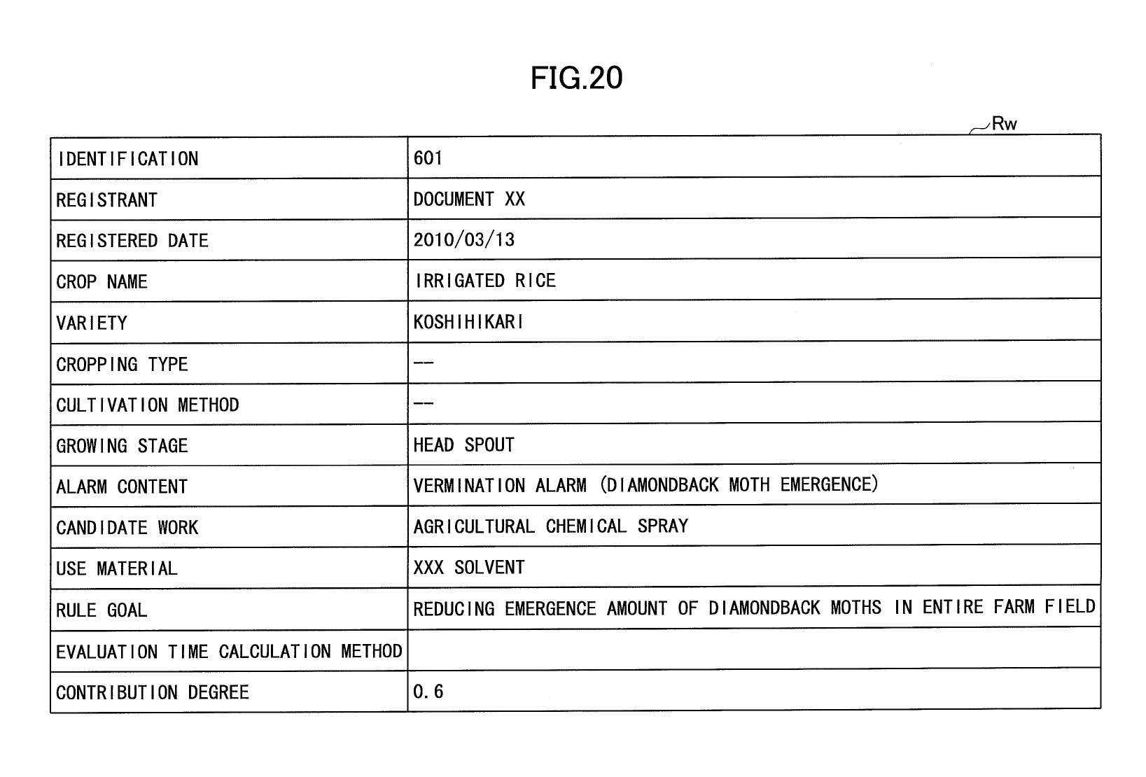

FIG. 20 is a diagram illustrating a configuration example of the alarm rule Rw. The alarm rule Rw corresponds to the work rule which defines the condition for the growing state of the crop and the alarm information, and the work task which is performed when the condition is satisfied. In FIG. 20, the alarm rule Rw includes items of a rule ID, a registrant, a registered date, a crop name, a variety, a cropping type, a cultivation method, a growing stage, an alarm content, a candidate work, use material, a rule goal, an evaluation time calculation method, a contribution degree, and the like. The rule ID, the registrant, the registered date, and the like are as described related to the growing state update rule Ru (FIG. 5) and the like.

The items from the crop name to the growing stage correspond to parameters forming the condition (the growing state condition) with respect to the growing state information in the alarm rule Rw.

The alarm content corresponds to a parameter forming the condition (the alarm condition) with respect to the alarm information in the alarm rule Rw. The alarm content indicates a content of the alarm information.

In step S503, the alarm rule Rw, which matches with items from the crop name to the growing stage with respect to the growing stage information and matches with the alarm content with respect to the alarm information, is retrieved.

When the alarm rule Rw is not retrieved (NO in step S504), the fourth extraction process in FIG. 19 is terminated. When the alarm rule Rw is retrieved (YES in step S504), the work rule extraction part 115 records the alarm rule Rw in the extraction rule storage part 116 (step S505). That is, the alarm rule Rw is extracted as the application candidate. Then, the fourth extraction process is terminated.

By conducting the processes in FIG. 12, FIG. 14, FIG. 16, and FIG. 19 in a predetermined term, the extraction rule storage part 116 is in a state in which one or more work rules, which are extracted based on various factors (the growing state, the observation, the environment, the alarm, and the like) in the predetermined term (may be one day), are recorded.

Next, a process procedure for outputting a work instruction based on the work rule recorded in the extraction rule storage part 116 will be described.

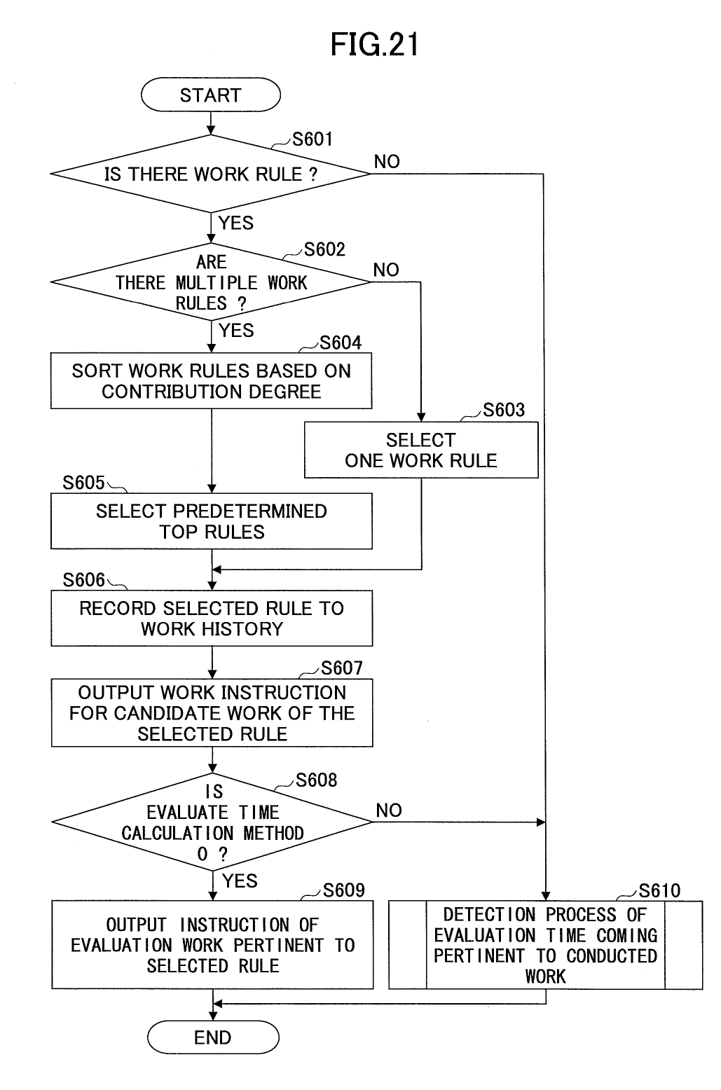

FIG. 21 is a flowchart for explaining an example of the process procedure of an output process of the work instruction. The output process in FIG. 21 may be periodically executed.

In step S601, the work instruction part 117 confirms whether the work rule is recorded in the extraction rule storage part 116. When there is no work rule recorded in the extraction rule storage part 116 (NO in step S601), the output process in FIG. 21 is terminated. Accordingly, in this case, the work instruction is not output.

When the work rule is recorded in the extraction rule storage part 116 (YES in step S601), the work instruction part 117 confirms whether multiple work rules are recorded in the extraction rule storage part 116 (step S602). If there is one work rule recorded in the extraction rule storage part 116 (NO in step S602), the work instruction part 117 selects the work rule as the application subject (step S603), and advances to step S606.

On the other hand, when the multiple work rules are recorded in the extraction rule storage part 116 (YES in step S602), the work instruction part 117 sorts the multiple work rules in descending order based on the contribution degree included in each of the multiple work rules (step S604). After that, the work instruction part 117 selects one or more work rules of a predetermined number (may be one work rule) from a top in a sort result (step S605). That is, the work rule having a greater contribution degree is selected. The predetermined number may be appropriately defined as a number of work tasks possible in one day, based on a number of workers.

Depending on the work tasks, there may be an exclusive relationship between the work tasks. That is, in a case of simultaneously conducting a work task A and a work task B, advantages of both the work task A and the work task B may not be sufficiently acquired. In this case, a correspondence table between multiple work tasks may be created in the auxiliary storage device 102, and a presence or absence of an exclusive relationship may be recorded in the correspondence table. When selecting the multiple work rules, the work instruction part 117 determines the presence or absence of the exclusive relationship between the candidate works for each of the work rules by referring to the correspondence table. When there is the exclusive relationship, the work instruction part 117 excludes the work rule having a lower contribution degree from the application subjects in the work rules pertinent to the exclusive relationship. In order to offset this exclusion, the work rule, which has not initially been selected, may be increased in rank and selected.

Next, the work instruction part 117 records a new record, which includes the cultivation ID, the farm field ID, the crop name, the cropping type, the cultivation method, the growing stage, the candidate work, and the rule ID of the work rule selected in step S603 or step S605 (step S606). The candidate work is recorded as the work name of the new record. Regarding the new record, the working day, the evaluated date, and the rule goal achievement evaluation value are not recorded at this stage. Accordingly, based on the records in which the working day is recorded, it is possible to specify a not-performed work task. Also, based on other records in which the evaluated date is not recorded, it is possible to specify the work rule in which an achievement degree with respect to the rule goal is not evaluated.

Next, the work instruction part 117 outputs (displays) a screen indicating an instruction of performing the candidate work of the work rule (hereinafter, called a “subject work rule”) selected in step S603 or step S605 at the display device 106 (step S607). That is, the work instruction is conducted.

In the screen, a work instruction content may be displayed with letters or may be displayed by emphasizing a place (farm field) or the like indicated to work on a map in the screen. The work content may be visually represented by a display color in the emphasized screen. Also, the work instruction may be transmitted to a mobile terminal or the like possessed by the worker through the network.

Next, the evaluation time detection part 125 determines whether the evaluation time calculation method set in the subject work rule indicates “0” (step S608). When the evaluation time calculation method indicates “0” (YES in step S608), the evaluation time detection part 125 determines that the current day is the evaluation time pertinent to the subject rule. Then, the evaluation indication output part 126 outputs (displays) a screen (hereinafter, called an “evaluation instruction screen”), which includes the rule goal, and the execution instruction of the work task (a work task for looking over the farm field or an evaluation work for confirming the farm field) of which the achievement degree of the rule goal is evaluated (step S609). As a result, it is possible for the worker to recognize to perform the evaluation work with the work task (specifically, after the work task) for which the execution instruction is output in step S607.

An output of the execution instruction of the evaluation work in step S609 may be conducted at the same time the work instruction is output in step S607. That is, when the evaluation time calculation method set in the subject work rule indicates “0”, processes in step S607 and step S609 may be simultaneously conducted. In this case, at one screen, the work instruction and the execution instruction of the evaluation work may be displayed.

On the other hand, when the evaluation time calculation method of the subject work rule does not indicate “0” (NO in step S608), the evaluation time detection part 125 and the like perform a first detection process at an advent of the evaluation time pertinent to the work which has already performed (may be a day before the evaluation time) (step S610). Then, the output process is terminated.

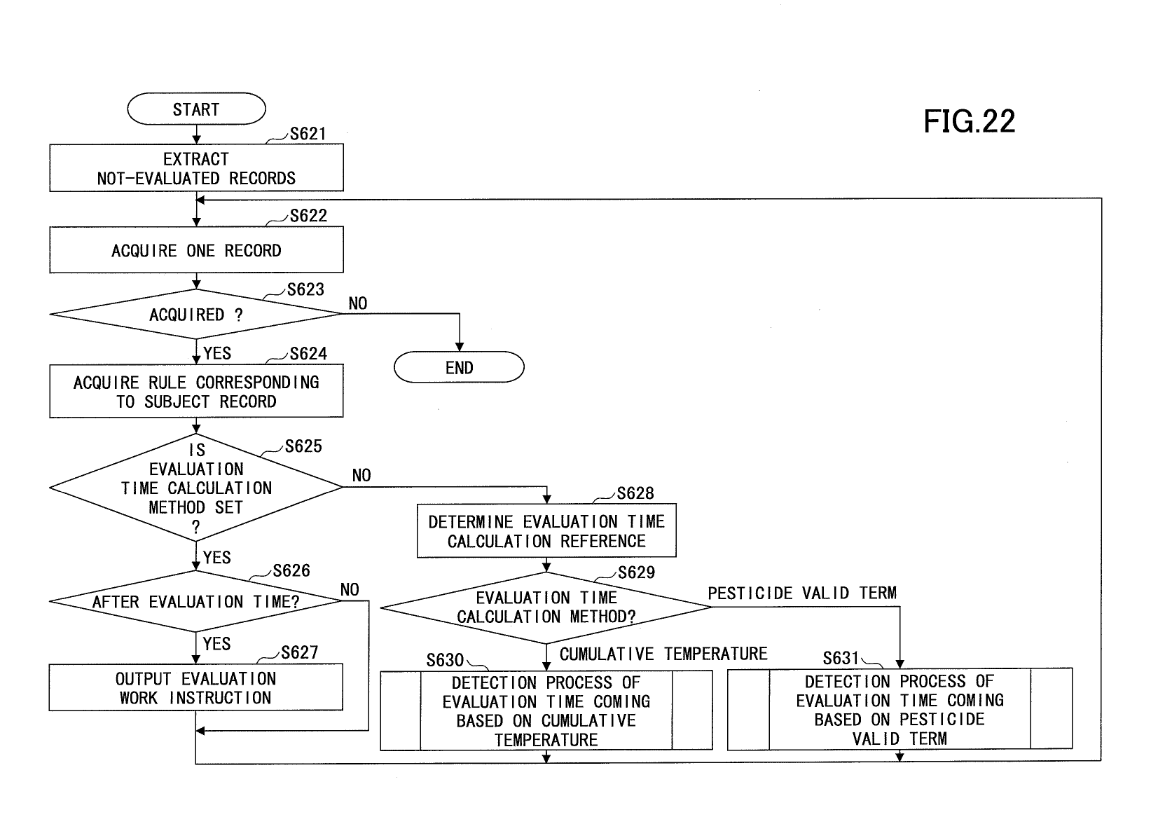

Next, a process in step S610 will be described. FIG. 22 is a flowchart for explaining an example of a process procedure of the first detection process of the advent of the evaluation time pertinent to a performed work task.

In step S621, the evaluation time detection part 125 extracts a set of records in which the evaluated date is not recorded (step S621), from the work history storage part 119 (FIG. 9). That is, the set of records (hereinafter, called a “not-evaluated record group”) in which the achievement degree of the rule goal has yet to be evaluated, is extracted.

Next, the evaluation time detection part 125 acquires one record from the not-evaluated record group (step S622). The acquired record (hereinafter, called a “subject history record”) is deleted from the not-evaluated record group. When the subject history record is acquired (YES in step S623), the evaluation time detection part 125 acquires the work rule pertinent to the rule ID recorded in the subject history record from the work rule storage part 114 (step S624). Hereinafter, the acquired work rule is called a “subject work rule”.

Next, the evaluation time detection part 125 determines whether a numeric value is set to the evaluation time calculation method of the subject work rule (step S625). That is, it is determined how many days the evaluated date is after the date when the work task is performed and whether the subject work rule is fixed.

When the numeric value is set (YES in step S625), the evaluation time detection part 125 determines whether the current day is after the evaluated date (step S626). That is, it is determined whether the evaluated date has come. Specifically, the evaluation time detection part 125 calculates the evaluated date by adding a numeric value set for the evaluation time calculation method of the subject work rule to the working date recorded in the subject history record. In this case, the current date indicates a date when the first detection process in FIG. 22 is executed. If the first detection process in FIG. 22 is performed after the work task for one day ends and before the date changes, the current date is corrected to a next day after the date when the first detection process in FIG. 22 is processed. On the other hand, if the first detection process in FIG. 22 is performed before the work task for one day begins, the current date is set the day the first detection process in FIG. 22 is performed. Accordingly, for the operation, setting information, which indicates whether the correction of the current date is conducted based on when the first detection process in FIG. 22 is performed, may be set.

When the current date is after the evaluated date (YES in step S626), the evaluation indication output part 126 outputs the rule goal of the subject work rule and an evaluation instruction screen at the display device 106 (step S627). The evaluation instruction screen includes an execution instruction of the evaluated work of the achievement degree of the rule goal. When the current date is prior to the evaluated date (NO in step S626), the output of the evaluation instruction screen is suppressed not to be displayed.

On the other hand, when the numeric value is not set to the evaluated date calculation method of the subject work rule (NO in step S625), the evaluation time detection part 125 determines a calculation reference of the evaluated date pertinent to the work name recorded in the subject history record by referring to the evaluation time calculation reference storage part 130 (step S628).

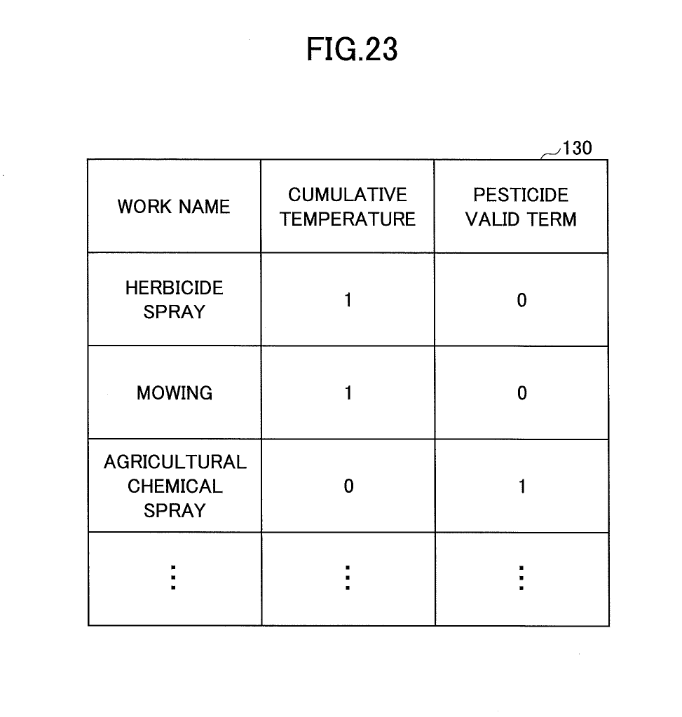

FIG. 23 is a diagram illustrating a configuration example of the evaluation time calculation reference storage part 130. The evaluation time calculation reference storage part 130 depicted in FIG. 23 stores information indicating what reference (or the parameter) the evaluated date is calculated based on. In FIG. 23, as the reference, a cumulative temperature and the pesticide valid term are indicated. The cumulative temperature indicates a cumulative temperature since the work task is performed and is used as the calculation reference of the evaluated date. The pesticide valid term indicates a valid term of the pesticide used for the work task and is used as the calculation reference of the evaluated date. In FIG. 23, a value “1” is recorded as either one of the cumulative temperature and the pesticide valid term for each of the work names. If the value “1” is recorded as the cumulative temperature for the evaluated date pertinent to the work name, the cumulative temperature is used as the reference. If the value “1” is recorded as the pesticide valid term for the evaluated date pertinent to the work name, the pesticide valid term is used as the reference.

In the above step S628, the evaluation time detection part 125 determines either the cumulative temperature or the pesticide valid term as the reference (to use) in order to calculate the evaluated term, by using the work name recorded in the subject history record with respect to the evaluation time calculation reference storage part 130.

If the cumulative temperature is used (the “cumulative temperature” in step S629), the evaluation time detection part 125 conducts a second detection process of the advent of the evaluation time pertinent based on the cumulative temperature (step S630). On the other hand, if the pesticide valid term is used (the “pesticide valid term” in step S629), the evaluation time detection part 125 performs a third detection process of the advent of the evaluated date based on the pesticide valid term (step S631).

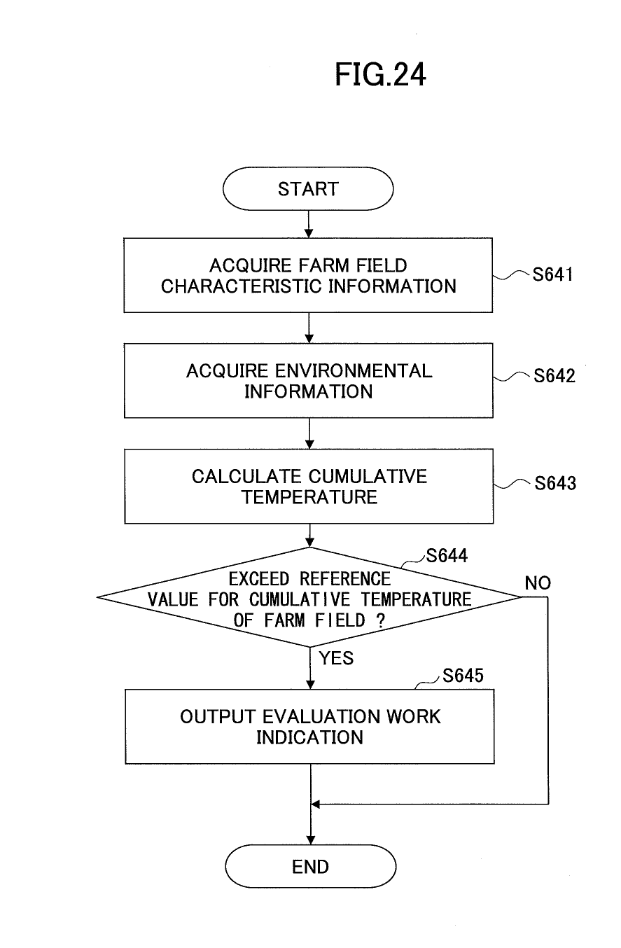

Next, the second detection process in step S630 will be described in detail. FIG. 24 is a flowchart for explaining an example of a process procedure of the second detection process of the advent of the evaluated date based on the cumulative temperature.

In step S641, the evaluation time detection part 125 acquires the farm field characteristic information corresponding to the farm field ID recorded in the subject history record from the farm field feature information storage part 128.

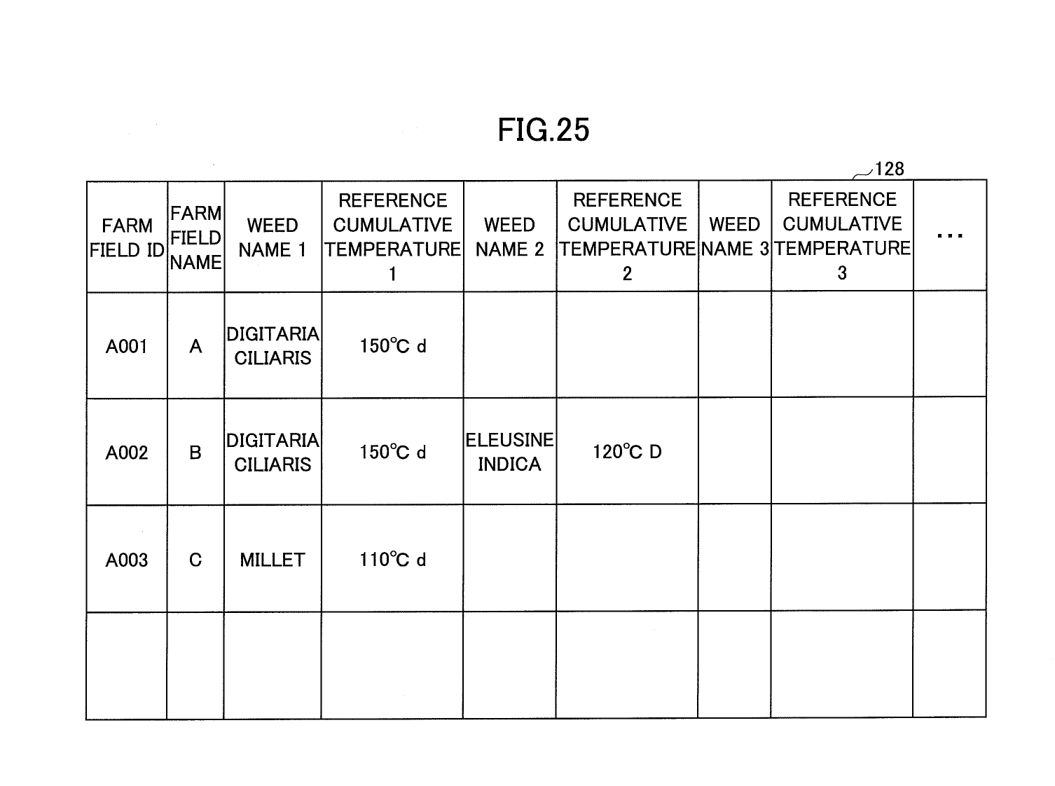

FIG. 25 is a diagram illustrating a configuration example of the farm field feature information storage part 128. In FIG. 25, the farm field feature information storage part 128 stores the farm field ID and the farm field name, and a weed name and reference cumulative temperature for each of weeds which may occur, for each of the farm fields.

The farm field name indicates a name of the farm field for the worker to distinguish the farm field. The weed name indicates a variety name of the weed. The reference cumulative temperature indicates the cumulative temperature at which the weed may occur. The cumulative temperature may be an integrated value of an average temperature of one day or may be the integrated value of a value which is acquired by deducting a growth limit temperature from the average temperature of one day.

Next, the evaluation time detection part 125 acquires the environmental information corresponding to the farm field ID recorded in the subject history record from the environmental information storage part 127 (FIG. 17) (step S642). Next, the evaluation time detection part 125 calculates the working day recorded in the subject history record (hereinafter, simply called “working day”) and the cumulative temperature of the term from a next day of the working day to the current date, based on the acquired environmental information (step S643). The cumulative temperature is calculated by a calculation method similar to that of the reference cumulative temperature of the farm field feature information storage part 128. In a case in which the work task is conducted in the evening, an influence of the average temperature of the working day with respect to the growth and development of the weed is considered. Thus, the working day may not be always included. Working times may be recorded in the work history storage part 119, and it may be determined whether to include the average temperature of the working date based on the working times. The average temperature of the current date may not be always included. In a case in which the process is conducted prior to the beginning of daily work, the average temperature of the current date has yet to be calculated. Accordingly, in this case, the average temperature of the current date may not be included in the cumulative temperature.

Next, the evaluation time detection part 125 compares the calculated cumulative temperature with each of the reference cumulative temperatures included the farm field characteristic information in step S641 for each of the weeds (step S644). When the calculated cumulative temperature exceeds the reference cumulative temperature of at least one variety of the weeds (YES in step S644), the evaluation time detection part 125 determines that the current date is the valuated date. Consequently, the evaluation indication output part 126 outputs the rule goal of the subject work rule and the evaluation indication screen, which includes the execution instruction of the evaluation work pertinent to the achievement degree of the rule goal, at the display device 106 (step S644). On the other hand, when the calculated cumulative temperature is lower than or equal to the reference cumulative temperature of all the varieties of the weeds included in the farm field characteristic information acquired in step S641 (NO in step S644), the evaluation time detection part 125 determines that the current date is not the evaluated date.

That is, there is no point in evaluating the achievement of a herbicide spray or the like in a state of less likelihood of the weed occurring regardless of the presence or absence of the herbicide spray. This determination is in effect waiting for a state in which the weed may occur and evaluating the achievement of the herbicide spray or the like. If herbicide spray exerts an effect as expected, even in a state where weeds may occur, weeds would not occur.

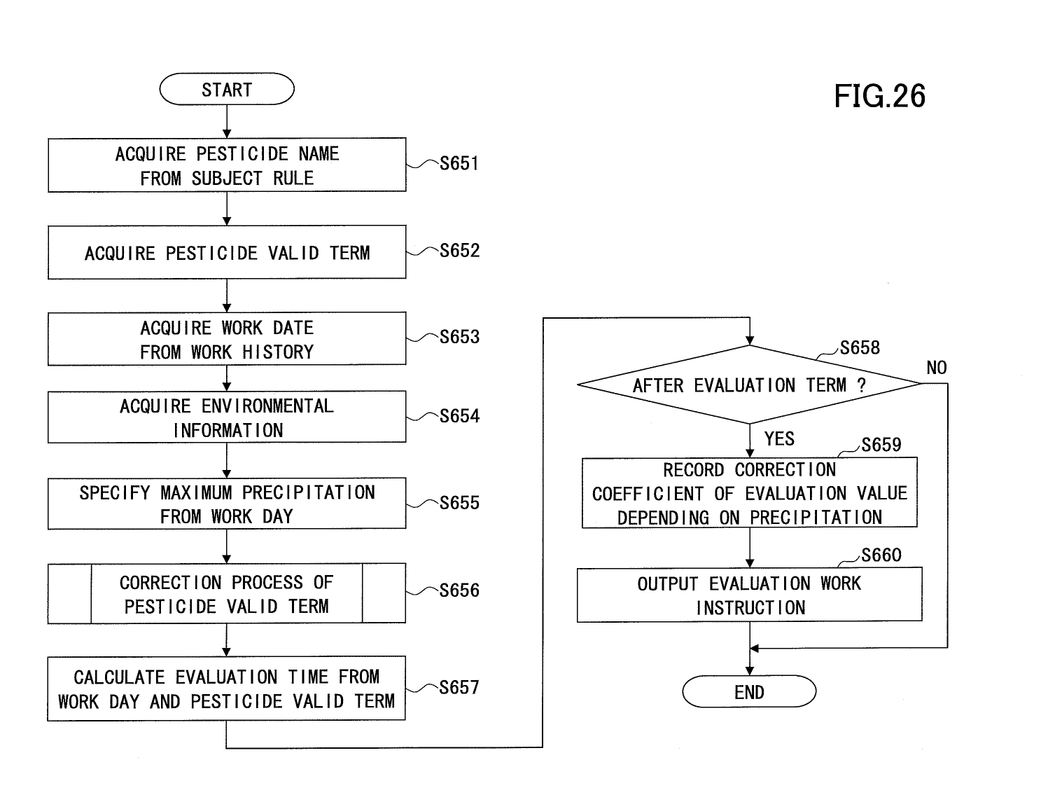

Next, the third detection process in step S631 in FIG. 22 will be described. FIG. 26 is a flowchart for explaining an example of a process procedure of the third detection process of the advent of the evaluated date based on the pesticide valid term.

In step S651, the evaluation time detection part 125 acquires the pesticide name from the item of the use material of the subject work rule. The pesticide name indicates a name of a pesticide used in the work task in accordance with the subject work rule. Next, the evaluation time detection part 125 acquires the valid term of the pesticide to use (step S652).

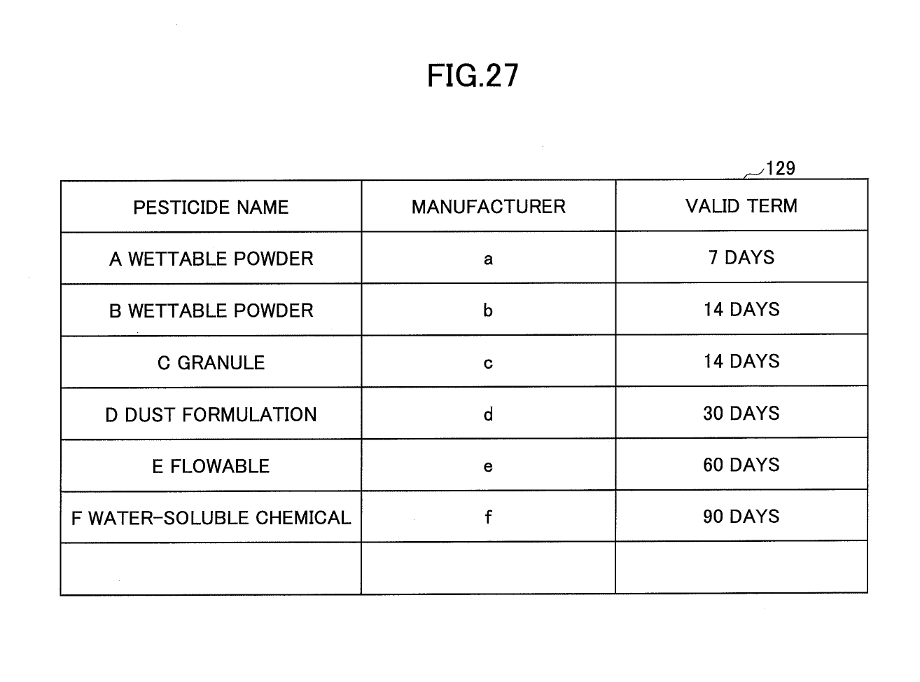

FIG. 27 is a diagram illustrating a configuration example of the pesticide information storage part 129. In FIG. 27, the pesticide information storage part 129 stores the pesticide name, a manufacturer, the valid term, and the like.

The pesticide name indicates the name (which may be a product name) of the pesticide. The manufacturer indicates a manufacturer name of the pesticide. The valid term indicates a term for which an effect of the pesticide lasts after the pesticide is sprayed.

Next, the evaluation time detection part 125 acquires the working date recorded in the subject history record (step S653). Next, the evaluation time detection part 125 acquires the environmental information which corresponds to the farm field ID recorded in the subject history record and which is of the working date and from the next day of the working date to the current date, from the environmental information storage part 127 (FIG. 17) (step S654). A setting of whether the environmental information of the working date or the current date is acquired may be approximately changed for the same reason as that described for a process in step S643 in FIG. 24.

Next, the evaluation time detection part 125 specifies a maximal value of the precipitation (hereinafter, called “maximum precipitation”) per day included in the acquired environmental information (step S655). That is, the precipitation of a day having the greatest precipitation since the working date is specified as the maximum precipitation.

Next, the evaluation time detection part 125 conducts the correction process of the valid term of the pesticide to use (step S656). That is, it is considered that if there is rainfall after the pesticide is sprayed and before the valid term of the pesticide lapses, the pesticide may be washed away by the rain, and the effect may be eliminated or degraded. That is, it is considered that the valid term of the pesticide may be shortened. Thus, in step S656, an original valid term of the pesticide is corrected depending on the maximum precipitation. Further details of step S656 will be described later.

Next, the evaluation time detection part 125 calculates the evaluated date by adding the valid term of the pesticide to use to the working date (step S657). If the valid term is corrected in step S656, the valid term after being corrected is added. Accordingly, in this case, the evaluated term is ahead of schedule.

Next, the evaluation time detection part 125 determines whether the current date is after the evaluated date (step S658). When the current date is after the evaluated date (YES in step S658), the evaluation time detection part 125 determines an evaluation value correction coefficient β depending on the maximum precipitation by referring to the evaluation value correction coefficient storage part 131. The evaluation time detection part 125 records a determination result in the item of the rule goal achievement evaluation value of the subject history record (step S659).

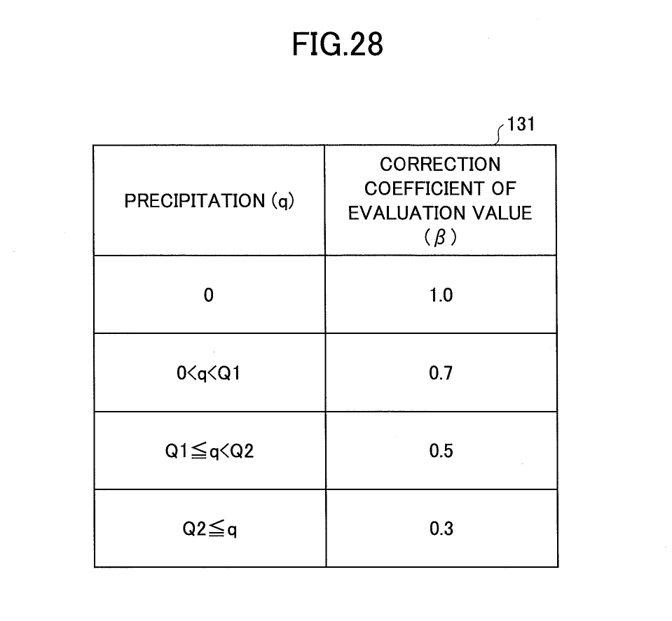

FIG. 28 is a diagram illustrating a configuration example of the evaluation value correction coefficient storage part 131. The evaluation value correction coefficient storage part 131 depicted in FIG. 28 stores the evaluation value correction coefficient β depending on the precipitation. Values of Q1 and Q2 may be approximately set as thresholds to distinguish an influence scale with respect to the valid term of the pesticide. Preferably, Q1=50 mm, and Q2=150 mm are set.

In the above described step S659, the evaluation time detection part 125 determines the evaluation value correction coefficient β by using the maximum precipitation with respect to the evaluation value correction coefficient storage part 131, and records the evaluation value correction coefficient β to the subject history record. As described later, when the rule goal achievement evaluation value pertinent to the subject history record is input, the evaluation value correction coefficient β is multiplied with the rule goal achievement evaluation value. As a result, the rule goal achievement evaluation value is corrected.

That is, even if the same achievement (which may be pest destruction) is acquired at the evaluation time for a first case and a second case, it is preferable to acquire different evaluation values. The first case may be a case in which the evaluation is performed when the original valid term of the pesticide lapses. The second case may be a case in which the evaluation is performed when a shortened valid term lapses. That is, even if the effect of the pesticide spray is sufficiently acquired when the shortened valid term due to the rainfall lapse, this result is not always the same as that expected with respect to the original valid term. In the embodiment, when the valid term is corrected, the rule goal achievement evaluation value is also corrected to optimize the evaluation.

Next, the evaluation indication output part 126 outputs the rule goal of the subject work rule and the evaluation instruction screen, which includes the execution instruction of the evaluation work of the achievement degree of the rule goal, at the display device 106 (step S660).

On the other hand, when the current date is prior to the evaluated date (NO in step S658), processes from step S659 are suppressed not to be conducted.

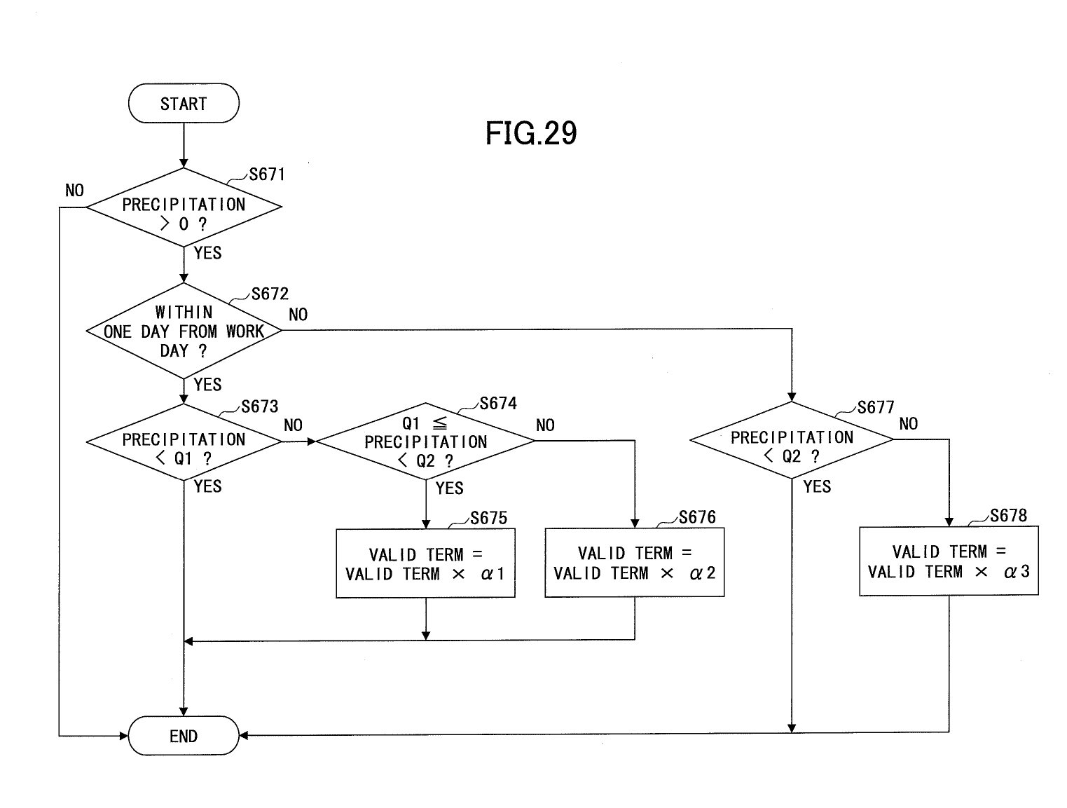

Next, a process of step S656 in FIG. 26 will be described in detail. FIG. 29 is a flowchart for explaining an example of a process procedure of a correction process of the pesticide valid term.

In step S671, the evaluation time detection part 125 determines whether the maximum precipitation is higher than 0 (zero). When the maximum precipitation is equal to 0 (zero) (NO in step S671), the valid term is not corrected. When the maximum precipitation is higher than 0 (zero) (YES in step S671), the evaluation time detection part 125 determines whether a day pertinent to the maximum precipitation is within one day (the working date or the next day of the working date) from the working date (step S672). The day pertinent to the maximum precipitation may be specified based on the environmental information acquired in step S654 in FIG. 26.

It is generally considered that an influence due to the rainfall is small with respect to the effect after the pesticide is dried. Thus, it is determined whether the day pertinent to the maximum precipitation is within one day from the working date. It is also considered that the influence is great with respect to the effect of the pesticide when there is rainfall immediately after the pesticide spray. It is in effect of changing a correction degree of the valid term depending on a rainfall time after the pesticide spray. In this effect, a number of reference days determined in step S672 may not be limited to one day.

When the day pertinent to the maximum precipitation is within one day from the working date (YES in step S672), the evaluation time detection part 125 determines whether the maximum precipitation is lower than Q1 (step S673). The values of Q1 and Q2 in FIG. 29 may be the same as those of Q1 and Q2 in FIG. 28. When the maximum precipitation is lower than Q1 (YES in step S673), the evaluation time detection part 125 does not correct the valid term. In a case in which the precipitation is lower, it is considered that the influence to the pesticide is smaller. Accordingly, it is preferable to set a maximum value of the precipitation, which is considered that there is no influence with respect to the effect of the pesticide, to Q1.

When the maximum precipitation is greater than or equal to Q1 (NO in step S673), the evaluation time detection part 125 determines whether the maximum precipitation is lower than Q2 (step S674). When the maximum precipitation is lower than Q2 (YES in step S674), the evaluation time detection part 125 sets a value, which is acquired by multiplying a correction coefficient α1 with the original valid term, to the valid term after the correction (step S675). On the other hand, when the maximum precipitation is greater than or equal to Q2 (NO in step S674), the evaluation time detection part 125 sets a value, which is acquired by multiplying a correction coefficient α2 with the original valid term, to the valid term after the correction (step S676). The correction coefficients α1 and α2 are less than 1, and have a relation of α1>α2. It is considered that the valid term becomes shorter when the precipitation is greater. Preferably, α1=0.5 and α2=0 are set.

On the other hand, when the day pertinent to the maximum precipitation is within one day from the working date (NO in step S672), the evaluation time detection part 125 determines whether the maximum precipitation is less than Q2 (step S677). When the maximum precipitation is less than Q2 (YES in step S677), the evaluation time detection part 125 does not correct the pesticide valid term. Accordingly, it is preferable to set the maximum value of the precipitation, which is considered that there is no influence to the effect of the pesticide after the pesticide has dried.

When the maximum precipitation is greater than Q2 (NO in step S677), the evaluation time detection part 125 sets a value, which if acquired by multiplying a correction coefficient α3 with respect to the original valid term, with the valid term after the correction (step S677). The correction coefficient α3 is less than 1, and has a relation of α3>α2. A magnitude relationship between α3 and α1 may be approximately defined. It is preferable to set α3=0.5. In this case, α3=α1.

An example, in which the execution instruction of the evaluation work is output related to the work task alone in which the current date is the evaluation time, is described above. In addition, the evaluation expected date may be output related to the work task in which the evaluation time has yet to come. By these outputs, it is possible for the worker to comprehend the evaluation expected date a few days prior.

Next, a process procedure, which is conducted when an input of the work achievement is performed by the worker who performed the work task in accordance with the work instruction based on the work rule, will be described.

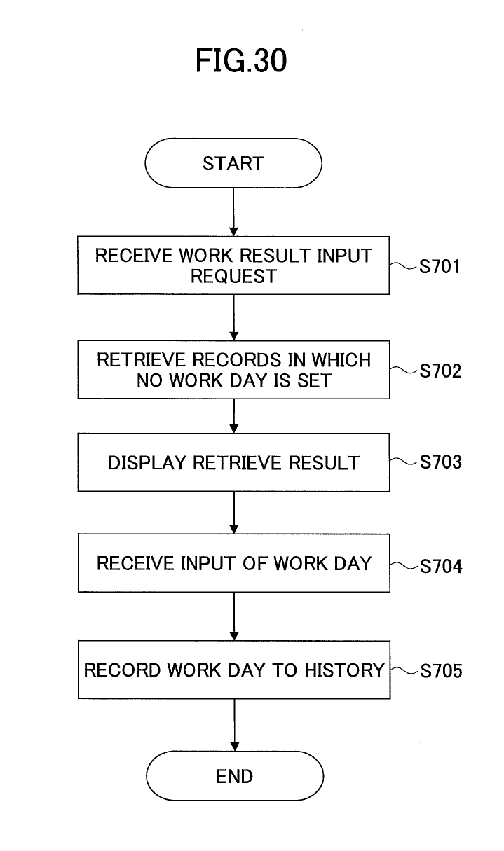

FIG. 30 is a flowchart for explaining an example of the process procedure of a first input process of the work achievement. The first input process in FIG. 30 is conducted after the worker performs the work task. The first input process in FIG. 30 may be conducted for all information related to the work tasks for one day at once.

In step S701, the work achievement input part 118 receives an input request of the work achievement. The input request may be conducted by using a well-known GUI (Graphical User Interface) including a clickable icon and the like.

Next the work achievement input part 118 retrieves records in which the working day is not recorded, from the work history storage part 119 (step S702). Next, the work achievement input part 118 displays a not-performed work list screen, which includes a list of the retrieved records, at the display device 106 (step S703). In this case, it is preferable to display the crop name, the cropping type, the cultivation method, the growing stage, the work name, and the like for each of the retrieved records in order for the worker to identify a correspondence between each of the retrieved records and a relevant work task.

Next, the work achievement input part 118 receives an input of the working day related to a record corresponding to the work performed by the worker in the records displayed in the not-performed work list screen (step S704). In rows of the records in the not-performed work list screen, the working date may be input. Alternatively, in response to a selection of one row, the work achievement input part 118 may display a working date input screen and input the working date through the working date input screen. Furthermore, when it is thoroughly operational to perform the first input process in FIG. 30 at a day when the work task is performed, the work achievement input part 118 automatically determines a current date as the working date in response to a predetermined operation (such as a double click or the like) with respect to the row in the not-performed work list screen.

Next, the work achievement input part 118 records the input working date in the record regarded as an input subject (step S705).

Next, a second input process will be described. The second input process is performed to output a result (that is, the rule goal achievement evaluation value) of the evaluation work conducted based on the execution instruction of the evaluation work, the result output by the evaluation indication output part 126 in step S627 in FIG. 22, step S645 in FIG. 24, step S660 in FIG. 26, and the like.

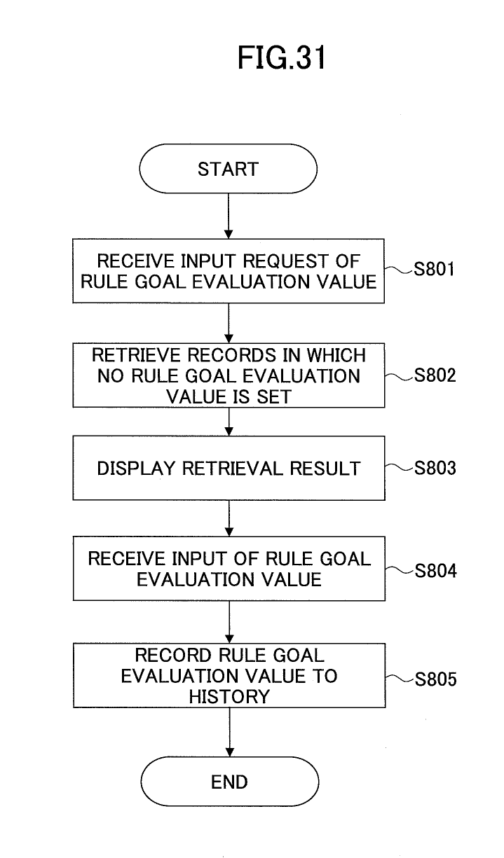

FIG. 31 is a flowchart for explaining an example of a process procedure of the second input process of the rule goal achievement evaluation value.

In step S801, the achievement degree input part 120 receives an input request of the rule goal achievement evaluation value. The input request may be conducted by using the well-known GUI (Graphical User Interface) including the clickable icon and the like.

Next, the achievement degree input part 120 retrieves records, in which the working date is recorded but the evaluated date is not recorded, from the work history storage part 119 (step S802). Next, the achievement degree input part 120 displays the not-evaluated work list screen including a list of the retrieved records, at the display device 106 (step S803). It is preferable to display the crop name, the cropping type, the cultivation method, the growing state, the work name, and the like for each of the retrieved records, and identify a correspondence between each of the retrieved records and a relevant work task.

Next, the achievement degree input part 120 receives an input of the rule goal achievement evaluation value pertinent to a record in which the evaluation work is conducted, in the records displayed in the not-evaluation work list screen (step S804). The rule goal achievement evaluation value may be input in rows of the records in the not-evaluated work list screen. In response to a selection of a row, the achievement degree input part 120 displays a rule goal achievement evaluation value input screen, and allows inputting the rule goal achievement evaluation value through the rule goal achievement evaluation value input screen.

The rule goal achievement evaluation value may be subjectively determined by the worker. The rule goal achievement evaluation value may be determined by a supervisor of the worker or the like other than the worker. In the embodiment, the rule goal achievement evaluation value is input by using a 100 level evaluation from 0 to 100. Also, a range of the stage goal achievement evaluation value is 0 to 100.

Next, the achievement degree input part 120 records the rule goal achievement evaluation value being input, in the record regarded as an input subject (step S805). In this case, the achievement degree input part 120 records a value, which is acquired by multiplying the evaluation value correction coefficient β with the rule goal achievement evaluation value, as the rule goal achievement evaluation value, regarding the records in which the evaluation value correction coefficient β is recorded in the item of the rule goal achievement evaluation value.

By repeating the above described process for each of cultivations, information recorded for previous cultivations is accumulated in the work history storage part 119 and the growing stage history storage part 122. Next, by using the work history storage part 119 and the growing stage history storage part 122, a process for calculating the contribution degree for each of the work rules (the contribution degree to the stage goal of the growing stage applied for the work rule) will be described.

First, the contribution degree will be organized. In the embodiment, the work rule may be arbitrarily registered by each of the workers. By this manner, knowledge possessed by each of the worker or acquired knowledge is integrated into the agricultural work support apparatus 10. As a result, it is possible for the agricultural work support apparatus 10 to output a proper work instruction based on the knowledge provided by each of the workers.

Some of the work rules may be registered based on information such as the Internet, documents, and the like which have been widely used. That is, some of the work rules may be registered based on experimental rules and the like which are considered to be reasonable in general terms. Accordingly, it is not certainly assured that all work rules are always valid for a specified farm field.

In the embodiment, the contribution degree is introduced as an index for evaluating an actual effectiveness with respect to the growth of the crop in the specific farm field (that is, the farm field to which the embodiment is applied) for each of the work rules. It is considered that it is possible to evaluate the effectiveness of the work rule for the growth of the crop by the contribution degree for each of the work rules. Accordingly, it is preferable to set respective work rules in order to achieve the stage goal of the growing stage to which a corresponding work rule is applied. In other words, it is preferable to integrate an execution of the work task in accordance with each of the work rules into the achievement of the stage goal of the growing stage in which the work task is performed. It is reasonable to define the contribution degree of the work rule as a degree for contributing to the stage goal of the growing stage.

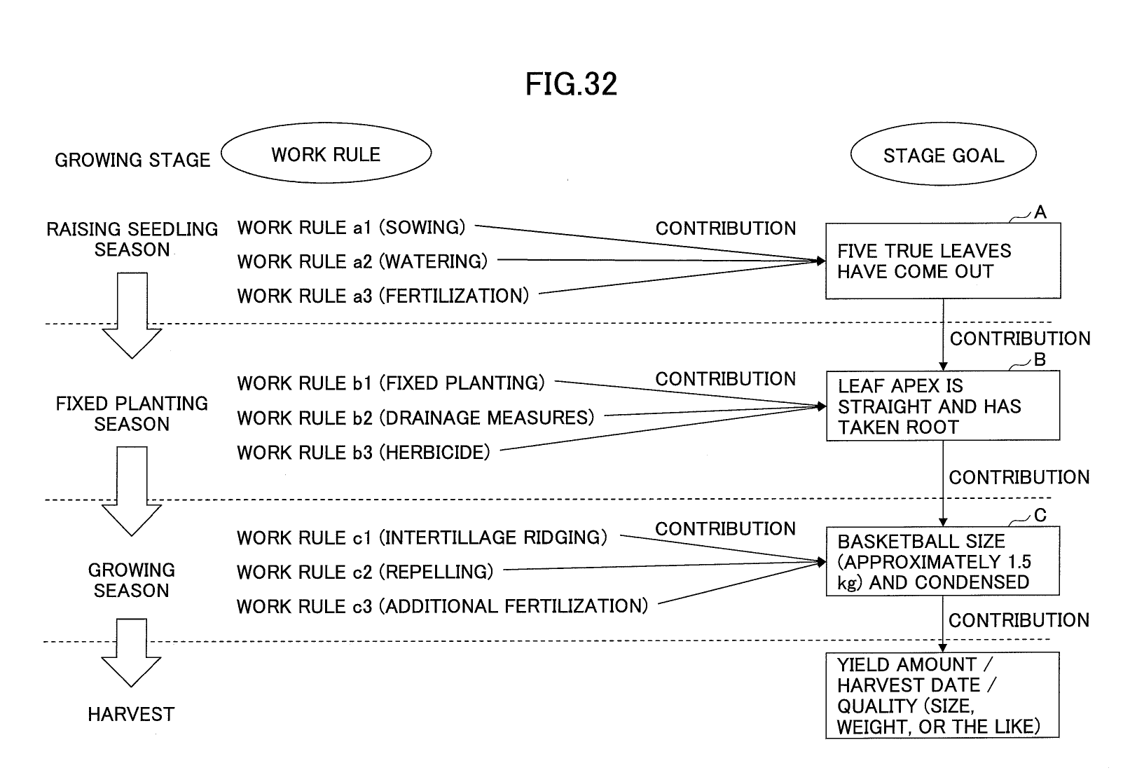

FIG. 32 is a diagram illustrating an example of a relationship between the work rules and the stage goals. In FIG. 32, as the growing stage, the raising seedling season, the fixed planting season, the growing season, and the like are illustrated. The stage goal of the raising seedling season corresponds to a stage goal A. The work rules, which are set for the raising seedling season, correspond to the work rule a1 through the work rule a3. Also, the stage goal of the fixed planting season corresponds to a stage goal B. The work rules, which are set for the fixed planting season, correspond to the work rule b1 through the work rule b3. Also, the stage goal of the growing season corresponds to a stage goal C. The work rules, which are set for the growing season, correspond to the work rule c1 through the work rule c3.

In FIG. 32, the work rules a1 through a3 preferably contribute to the achievement of the stage goal A. Moreover, the work rules b1 through b3 preferably contribute to the achievement of the stage goal B. Furthermore, the work rules c1 through c3 preferably contribute to the achievement of the stage goal C.

In this case, the contribution directly corresponds to a contribution of the work task performed in accordance with the work rule. However, a reason to perform the work task is based on the condition in the work rule. That is, the effectiveness of the work task to be performed based on the work rule changes depending on a presence or absence of the setting of the conditions in the work rule. Accordingly, in this case, the contribution corresponds to a contribution of the entire definition contents of the work rule.

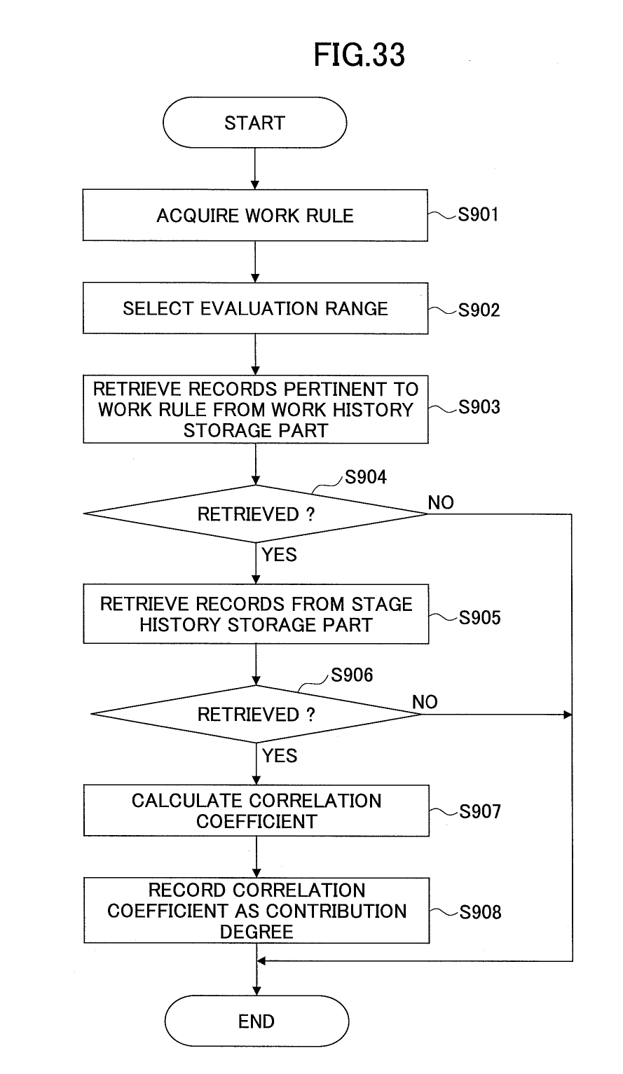

In the following, a calculation process of the contribution degree will be described in detail. FIG. 33 is a flowchart for explaining an example of a process procedure of the calculation process of the contribution of the work rule. The calculation process in FIG. 33 is automatically conducted when the stage goal achievement evaluation value is recorded, related to the cultivation being repeated multiple times (for a predetermined number of times) for the same crop. The greater the predetermined number of times, the better. The calculation process in FIG. 33 may be conducted when the cultivation ends. Alternatively, the calculation process in FIG. 33 may be conducted in response to an instruction input by a user.

In step S901, the contribution degree calculation part 123 acquires one work rule to be the process subject from the work rule storage part 114. The calculation process in FIG. 33 is sequentially conducted for the work rules stored in the work rule storage part 114. An order acquired in step S901 is not limited to a predetermined order. In the following, the work rule set as the process subject is called a “current work rule”.

Next, the contribution degree calculation part 123 selects an evaluation range of the contribution degree (step S902). Specifically, the contribution degree calculation part 123 selects to calculate the contribution degree pertinent to a specific farm field (the farm field ID) or to calculate the contribution degree, which does not limit the farm field (the farm field ID). The selection may be conducted based on setting information which is set beforehand. In a case in which the evaluation range of the contribution degree is limited to the specific farm field, the farm field ID of the farm field is recorded in the setting information. On the other hand, in a case in which the evaluation range of the contribution degree is not limited, no information is recorded in the setting information or information indicating that the evaluation range is not limited is recorded in the setting information. In a case in which the calculation process in FIG. 33 is conducted in response to an instruction of the user, the user may be allowed to interactively select whether the evaluation range of the contribution degree is limited to the specific farm field, and the farm field ID of the farm field if limited to the specific farm field.

Next, the contribution degree calculation part 123 retrieves (acquires) the rule goal achievement evaluation value pertinent to the current work rule from the work history storage part 119 (step S903). Specifically, records including the rule ID of the current work rule are retrieved. However, in a case in which the evaluation range of the contribution degree is limited to the specific farm field, the records to be retrieval subjects are limited to those including the farm field ID of the farm field. In a case in which the current work rule is applied (used) multiple times, multiple records are extracted.

Next, the contribution degree calculation part 123 determines whether at least one record is retrieved (step S904). When no record is retrieved, that is, when the current work rule has not been previously applied (NO in step S904), the calculation process for the current work rule is terminated.

On the other hand, when the records are retrieved (YES in step S904), the contribution degree calculation part 123 retrieves records, in which the cultivation ID and the growing stage correspond to those of any one of retrieved records in step S903, from the growing stage history storage part 122 (step S905). Next, the contribution degree calculation part 123 determines whether at least one record is retrieved (step S906). When no value of the rule goal is retrieved (NO in step S906), the calculation process for the current work rule is terminated.

On the other hand, when at least one record is retrieved (YES in step S906), the contribution degree calculation part 123 calculates a correlation coefficient based on a set of the rule goal achievement evaluation values included in the retrieved records from the work history storage part 119 in step S903 and a set of the stage goal achievement evaluation values included in the retrieved records from the growing stage history storage part 122 in step S905 (step S907).

Specifically, it is assumed that x denotes the set of the rule goal achievement evaluation values and y denotes the set of the stage goal achievement evaluation value. The following calculation is performed.

First, a standard deviation S(x) pertinent to x is calculated. Next, a standard deviation S(y) pertinent to y is calculated. Next, a common variance of x and y is calculated by the following expression.

$$S ( x , y ) = average deviation \\ = \frac{( S ( x ) n + S ( y ) m )}{( n + m )}$$

In this expression, n denotes a number of elements of x and m denotes a number of elements of y.

Next, a correlation coefficient r(x, y) is calculated by the following expression.

r(x,y)=S(x,y)/(S(x) xS(y))

In this expression, x corresponds to the set of the rule goal achievement evaluation values for the work rule X, and y corresponds to the set of the stage goal achievement evaluation value for a certain growing stage Y. In this case, r(x, y) represents the correlation coefficient between the rule goal achievement evaluation values of the work rule X and the stage goal achievement evaluation values of the growing stage Y. It is assumed that when each of x and y becomes greater, the achievement becomes higher. It may be seen that when the correlation coefficient r(x, y) is closer to one (that is, when a positive correlation is greater), the rule x greatly contributes to the achievement of the stage goal of the stage Y.

Next, the contribution degree calculation part 123 re-writes the correlation coefficient r(x, y) calculated by the above expression to the contribution degree of the current work rule (step S908). Accordingly, when the contribution degree has been already recorded in the current work rule, the contribution degree is updated by a new value.

On the other hand, when the contribution degree is not recorded in the current rule, the correlation coefficient r(x, y) is recorded as the contribution degree.

The above described steps S901 to S908 are conducted for all work rules recorded in the work rule storage part 114. Thus, the contribution degree is updated for each of the work rules.

The correlation coefficient is one example. Thus, the stage goal achievement evaluation value and the rule goal achievement evaluation value are evaluated by another statistical index.

As described above, according to the embodiment, it is possible to instruct the worker to perform an appropriate work task at an appropriate time by considering a special circumstance, an environmental state, and the like of the farm field as well as the growing state of the crop. An appropriate work instruction is output in response to the input information indicating various circumstances occurring at the farm field and its circumference. The input information may include the observation information (which may indicate an occurrence state of the pest) related to the crop, the soil, and the like at the farm field, the environmental information pertinent to the farm field and its circumference (which may indicate the temperature, the sunshine duration, the humidity, the precipitation, and the like), various alarm information (which may indicate the typhoon information, the pest occurrence prediction, and the like).

Also, when the multiple work rules are conflicted, the work rule, which is applied based on the contribution degree of the work rule, is selected (restricted). The contribution degree indicates a degree of the contribution of the work rule pertinent to the growth of the crop (that is, pertinent to the achievement of the stage goal), which is calculated based on a previous achievement. Accordingly, by selecting the work rule based on the contribution degree, it is possible to improve likelihood of performing the work highly contributing to the growth of the crop (that is, the achievement of the stage goal).

Moreover, in the embodiment, the growing state information is updated to be a value in line with the actual growing state of the crop based on the growing state update rule Ru and the observation rule Ro, in addition to being simply updated mechanically depending on a lapse of time. The growing state information corresponds to one set of the input information in order to determine which work rule is applied. Accordingly, by maintaining a value which is approximated to an actual state of the crop for the growing state information, it is possible to improve accuracy of selecting the work rule based on the growing state information.

In the embodiment, the example, in which the work rule is selected based on the contribution degree when the multiple work rules are conflicted, is described above. However, the work rule may be selected based on another factor. A priority may be set beforehand with respect to the registrant for each of the work rules. Specifically, the priority is defined among persons possible to be the registrant, a document, a URL (Uniform Resource Locator), and the like. In this case, the work rule to apply may be selected based on the priority for the registrant for each of the work rules. Moreover, the priority may be set for a type of the work rule. In a case of setting a priority order such as the alarm rule Rw>the observation rule Ro>the environmental rule Re>the growing state rule Rs, it is possible to prioritize the work task based on the alarm and the observation result.

Moreover, in a case in which it is not possible to restrict the work rules by the contribution degree alone (that is, in a case in which the contribution degrees of the work rules are the same), the above described selection methods may be combined.

Furthermore, in the embodiment, for each of the work tasks which the work history storage part 119 records, the advent of the evaluated date is automatically detected based on a performed date of the work task, and the evaluation time calculation method recorded in the work rule which is a basis of the work task. Then, the execution instruction of the evaluation work is output.

Accordingly, it is possible for the worker to know the advent of the evaluation time without conducting schedule management and the like by himself. Especially, in a case in which there is a time lag between a timing of performing the agricultural work task and a timing of performing the evaluation work pertinent the agricultural work task, it is possible to prevent selecting an improper evaluation time by the worker and forgetting the evaluation work.

Moreover, the evaluation time pertinent to a specific agricultural work task is dynamically calculated depending on the environmental circumstance (mainly, a weather circumstance) of the farm field. Accordingly, compared with a case of uniformly calculating the evaluation time, it is possible to notify the worker of the evaluation time highly corresponding to an actual circumstance of the farm field.

Accordingly, it is possible to support the evaluation of the achievement of the agricultural work task.

In the embodiment, the work rule storage part 114, the evaluation time calculation reference storage part 130, and the like are examples of a calculation method storage part. Moreover, the evaluation indication output part 126 is an example of a detection part. Furthermore, the evaluation indication output part 126 is an example of an output part. The pesticide and the herbicide are examples of an agrichemical.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An agricultural work support method performed in a computer, the method comprising:
detecting an advent of an evaluation time of a performed agricultural work task based on a performance time and a calculation method of the evaluation time of an achievement of the agricultural work task, in which a work history storage part stores the performance time for each of multiple agricultural work tasks, and a calculation method storage part stores the performance time as a reference in the calculation method; and
outputting an instruction of an evaluation work of the achievement pertinent to the agricultural work task in which the advent of the evaluation time is detected.

2. The agricultural work support method as claimed in claim 1, wherein the detecting detects the advent of the evaluation time of the agricultural work task based on a history of weather information from the performance time which a weather history storage part stores, for the agricultural work task for which the work history storage part stores the evaluation time.

3. The agricultural work support method as claimed in claim 2, wherein the detecting detects the advent of the evaluation time of the agricultural work task when a cumulative temperature since the performance time exceeds a reference value at which a living organism to be eliminated by the agricultural work task occurs.

4. The agricultural work support method as claimed in claim 1, wherein the detecting detects the advent of the evaluation time of the agricultural work task at a time which is acquired by adding a valid term of an agrichemical used by the agricultural work task.

5. The agricultural work support method as claimed in claim 4, wherein the detecting corrects a valid term of the agrichemical depending on precipitation since the performance time.

6. An agricultural work support apparatus, comprising:
a detection part configured to detect an advent of an evaluation time of a performed agricultural work task based on a performance time and a calculation method of the evaluation time of an achievement of the agricultural work task, in which a work history storage part stores the performance time for each of multiple agricultural work tasks, and a calculation method storage part stores the performance time as a reference in the calculation method; and
an output part configured to output an instruction of an evaluation work of the achievement pertinent to the agricultural work task in which the advent of the evaluation time is detected.

7. The agricultural work support apparatus as claimed in claim 6, wherein the detection part detects the advent of the evaluation time of the agricultural work task based on a history of weather information from the performance time which a weather history storage part stores, for the agricultural work task for which the work history storage part stores the evaluation time.

8. The agricultural work support apparatus as claimed in claim 7, wherein the detection part detects the advent of the evaluation time of the agricultural work task when a cumulative temperature since the performance time exceeds a reference value at which a living organism to be eliminated by the agricultural work task occurs.

9. The agricultural work support apparatus as claimed in claim 6, wherein the detection part detects the advent of the evaluation time of the agricultural work task at a time which is acquired by adding a valid term of an agrichemical used by the agricultural work task.

10. The agricultural work support apparatus as claimed in claim 6, wherein the detection part corrects a valid term of the agrichemical depending on precipitation since the performance time.
